(19) United States
(12) Patent Application Publication
(10) Pub. No.: US 2024/0171340 A1
(43) Pub. Date: May 23, 2024

(54) NEW RADIO POSITIONING REFERENCE SIGNAL ENHANCEMENTS

(71) Applicant: INTERDIGITAL PATENT HOLDINGS, INC., Wilmington, DE (US)

(72) Inventors: Jerome VOGEDES, Milwaukee, WI (US); Pascal ADJAKPLE, Great Neck, NY (US); Rocco DI GIROLAMO, Laval (CA); Yifan LI, Conshohocken, PA (US); Kyle PAN, Saint James, NY (US); Guodong ZHANG, Woodbury, NY (US); Kai-Erik SUNELL, Naantali (FI)

(21) Appl. No.: 18/552,518

(22) PCT Filed: Mar. 25, 2022
(86) PCT No.: PCT/US2022/021935

§ 371 Date: Sep. 26, 2023

Related U.S. Application Data
(60) Provisional application No. 63/168,369, filed on Mar. 31, 2021.
(60) Provisional application No. 63/185,642, filed on May 7, 2021.

(51) Int. Cl. H04L 5/00; H04W 64/00

(52) U.S. Cl. CPC H04L 5/0048; H04W 64/003

(57) ABSTRACT

Radio network Positioning Reference Signals (PRSs) may be managed dynamically via user equipment (UE) requests triggered by measurements in accordance with initial PRS configurations, whereby a UE contacts an Access and Mobility Management Function (AMF) and/or a Location Management Function (LMF). Similarly, an LMF may initiate adjustments in PRS configurations and transmission via communications with base stations, UEs, and/or AMFs. Dynamic signaling of PRS configurations may be achieved via legacy protocols and/or New Radio Positioning Protocol A (NRPPa), for example. A requests from a UE for PRS configuration adjustment may include an indication of a required level of service or of a class of service, for example, and/or an indication of signal measurements, a position estimate, an indication of a capability of the UE.

### CROSS-REFERENCE TO RELATED APPLICATIONS

This application claims the benefit of U.S. Provisional Patent Application No. 63/168,369, filed on Mar. 31, 2021, and U.S. Provisional Patent Application No. 63/185,642, filed on May 7, 2021, both titled “New radio positioning reference signal enhancements,” the content of which are hereby incorporated by reference herein.

### BACKGROUND

This disclosure pertains to the operation of devices on wireless network, such as those described in: 3GPP TS 38.305 Stage 2 functional specification of User Equipment (UE) positioning in NG-RAN (Rel-16); 3GPP TS 37.355 LTE Positioning Protocol (LPP), Release 16; 3GPP TS 38.331, Radio Resource Control (RRC) protocol specification (Release 16); 3GPP TS 38.413, NGAP (NG Application Protocol); 3GPP TS 38.445 NR Positioning Protocol A (NRPPa), Release 16; 3GPP TS 38.211, NR, Physical Channels and Modulation (Rel-16); 3GPP TS 38.300, NR and NG-RAN Overall Description; Stage 2 (Release 16); 3GPP TR 38.857, Study on NR positioning enhancements (Release 17); 3GPP TS 38.212, NR; Multiplexing and channel coding (Release 16); 3GPP TS 38.321, NR; Medium Access Control (MAC) protocol (Release 16); 3GPP TS 36.331, Evolved Universal Terrestrial Radio Access (E-UTRA); Radio Resource Control (RRC) (Release 16); 3GPP TS 36.300, Evolved Universal Terrestrial Radio Access (E-UTRA) and Evolved Universal Terrestrial Radio Access Network (E-UTRAN); Overall description; Stage 2 (Release 16).

### SUMMARY

The efficiency of radio network operations, for example, may be improved by the use of dynamic positioning reference signals. For example, user equipment (UE) may be provided with an initial configuration for Positioning Reference Signal (PRS) operations, where the initial configuration includes criteria for determining when to request assistance from the network with regard to such positioning reference signals. When criteria are met, the UE may send a LoCation Services (LCS) request to an Access and Mobility Management Function (AMF), and then receive an updated PRS configuration from a Location Management Function (LMF). The LMF may also provide the initial and updated PRS configurations to a base station/gNB. Similarly, the UE may, based on measurements and trigger criteria, send a PRS resource request to the LMF.

Requests from the UE may include an indication of a required level of service or of a class of service, for example, and/or an indication of signal measurements, a position estimate, or an indication of a capability of the UE.

PRS configurations may be exchanged using New Radio Positioning Protocol A, NRPPa, and/or via RRC or legacy protocols. A PRS configuration may include an indication of a period of time in which the updated PRS configuration is to be used, and/or a positioning System Information Block (posSIB.)

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 is a block diagram of an example CP/UP architecture.

FIG. 2 is a block diagram of an example of NR positioning interfaces and nodes.

FIG. 3 is a call flow of an example of a general LCS procedure.

FIG. 4 is a call flow of an example of LPP messaging for a single position/measurement request.

FIG. 5 is a block diagram illustrating multi-lateration techniques.

FIG. 6 is a call flow of an example of a UE request for reference signal reconfiguration.

FIG. 7 is a flow chart of an example of UE criteria for triggered PRS (re)configuration.

FIG. 8 is a call flow of an example of LMF initiation of PRS transmission configuration.

FIG. 9 is a flow chart of an example of LMF initiated positioning reconfiguration process.

FIG. 10A illustrates an example communications system.

FIGS. 10B-D are system diagrams of example RANs and core networks.

FIG. 10E illustrates another example communications system.

FIG. 10F is a block diagram of an example apparatus or device, such as a WTRU.

FIG. 10G is a block diagram of an exemplary computing system.

### DETAILED DESCRIPTION

Many of the abbreviations used herein are described in Item 22 of the Appendix.

NR PRS Background, Use Cases and Deployment Scenarios

Release 16 NR Positioning Protocols and Signals

Positioning protocols and RAN-based positioning signals have been specified in 3GPP since Release 9 LTE for enabling emergency services and location-based services.

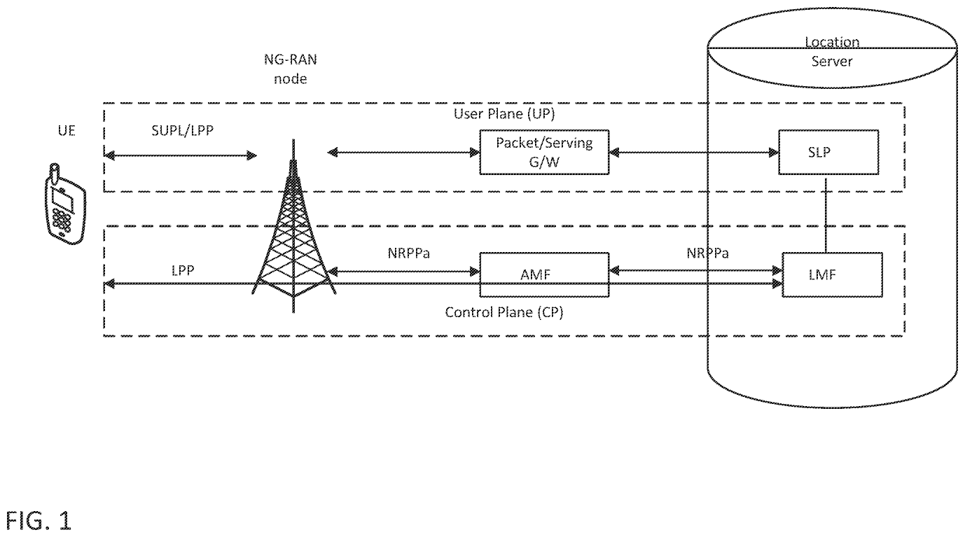

In Rel-16, 3GPP NR positioning protocols are supported by the Control Plane (CP) positioning architecture. The NR architecture may also be supported by a Secure User Plane Location (SUPL) server, also known as a SUPL Location platform (SLP), that may leverage any IP bearer. Interworking for CP and UP positioning solutions are defined in TS 38.305, where SUPL can also be used as a tunnel for CP positioning protocols (e.g., LPP). See 3GPP TS 38.305 Stage 2 functional specification of User Equipment (UE) positioning in NG-RAN (Rel-16). See FIG. 1.

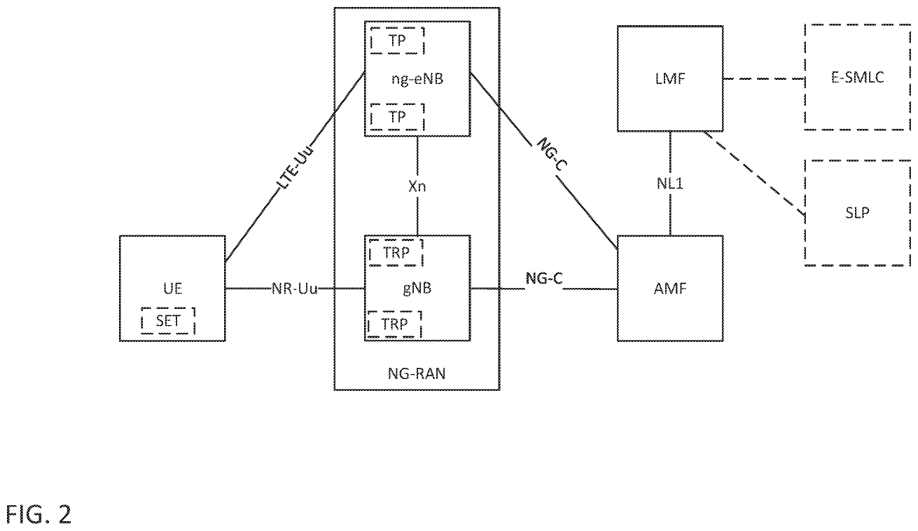

The associated positioning nodes and interfaces are shown in FIG. 2, which also includes legacy LTE interfaces. 3GPP has defined various protocols to enable positioning technologies and methods, such as GNSS, sensors, positioning signals, etc.) The primary protocol, LPP (LTE Positioning protocol), is terminated between the UE and LMF (Location Management Function). LPP is a Point-to-Point LCS and NAS messaging protocol that is defined in 3GPP TS 37.355 LTE Positioning Protocol (LPP), Release 16. LPP was agreed to be re-used for NR since Rel-15 and will continue to be leveraged.

RRC (Radio Resource Control) is another protocol used to provide transport for LPP messages and other positioning procedures over the NR-Uu interface, which is terminated between the gNB and the UE. See 3GPP TS 38.331, Radio Resource Control (RRC) protocol specification (Release 16).

On the network side, NGAP (NG Application Protocol) is terminated between the AMF and the NG-RAN Node(s) (i.e., gNB/TRP) and is used as a transport for LPP and NRPPa messages over the NG-C interface. See 3GPP TS 38.413, NGAP (NG Application Protocol).

Finally, NRPPa (NR Positioning Protocol A) carries information between the NG-RAN Node(s) and the LMF. See 3GPP TS 38.445 NR Positioning Protocol A (NRPPa), Release 16.

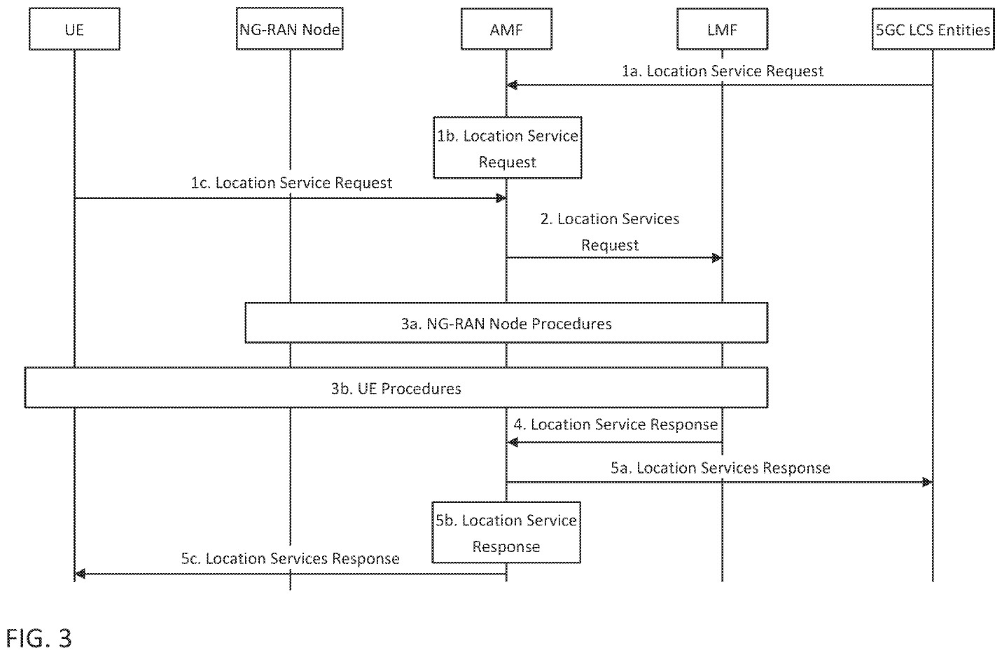

From a protocol perspective for Rel-16, FIG. 3 illustrates a general LCS flow, adopted from TS 38.305.

In step 1a, some entity in the 5GC (e.g., GMLC—G/W Mobile Location Center) requests some location service (e.g., positioning) for a target UE to the serving AMF. Alternatively, in step 1b the serving AMF for a target UE determines the need for some location service (e.g., to locate the UE for an emergency call). Or, in step 1c the UE requests some location service (e.g., positioning or delivery of assistance data) to the serving AMF at the NAS level.

In step 2, the AMF transfers the location service request to an LMF.

In step 3a, the LMF instigates location procedures with the serving and possibly neighboring ng-eNB or gNB in the NG-RAN—e.g., to obtain positioning measurements or assistance data.

In step 3b, in addition to step 3a or instead of step 3a, the LMF instigates location procedures with the UE—e.g., to obtain a location estimate or positioning measurements or to transfer location assistance data to the UE.

In step 4 the LMF provides a location service response to the AMF and includes any needed results—e.g., success or failure indication and, if requested and obtained, a location estimate for the UE.

In step 5a, if step 1a was performed, the AMF returns a location service response to the 5GC entity in step 1a and includes any needed results—e.g., a location estimate for the UE.

In step 5b, if step 1b occurred, the AMF uses the location service response received in step 4 to assist the service that triggered this in step 1b (e.g., may provide a location estimate associated with an emergency call to a GMLC).

In step 5c, if step 1c was performed, the AMF returns a location service response to the UE and includes any needed results—e.g., a location estimate for the UE.

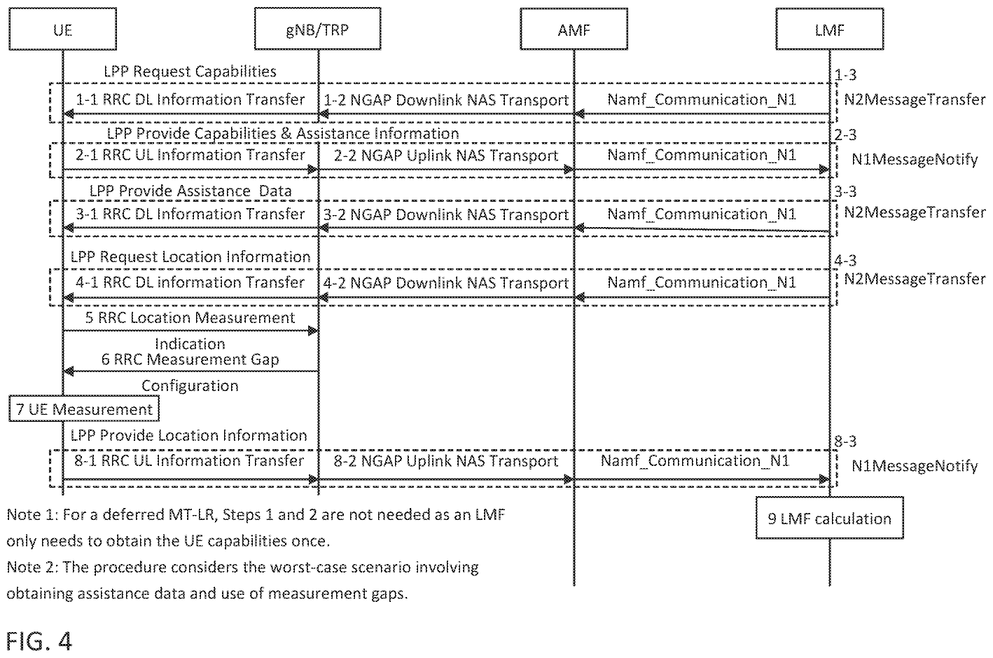

Looking at the positioning procedures related to UE procedures in step 3b of FIG. 3 a bit closer, the LPP messages related to UE-assisted location request(s) are shown in FIG. 4. In the example of FIG. 4, in step 1 the LMF requests UE capabilities, and in step 2, the UE provides the capabilities. In step 3, the UE receives assistance data, and in step 4, the UE receives location information from the LMF. LMF to UE positioning assistance data may include information/configuration. Broadcast of positioning Assistance Data (AD) is supported via Positioning System Information Blocks (posSIBs) and carried in SI messages See 3GPP TS 38.331 and See 3GPP TS 38.413.

In step 5 of FIG. 4, the UE sends an RRC location measurement indication, and in step 6, the gNB/TRP sends an RRC measurement gap configuration. In step 7, the UE conducts measurements, which are relayed in step 8. In step 9, the LMF performs its calculations.

NR Positioning Use Cases

Positioning may be achieved in standalone, UE-based, or UE-assisted modes.

In Standalone positioning, the UE handles all aspects of the positioning, scans for accessible sources of positioning, measures, and processes positioning signals/sources. Finally, the UE computes its own position in 2 or 3 dimensions. In Standalone positioning, the Uu interface impacts include UE capability exchange and reporting of the UE position.

In UE-Based Positioning (UE-B), the network provides acquisition assistance data, and the UE scans for accessible sources of positioning, measures, and processes positioning signals/sources (based on assistance information from the network). Finally, the UE computes its own position in 2 or 3 dimensions and may report its position to the network.

In UE-Assisted Positioning (UE-A), the network provides acquisition assistance, and the UE scans for accessible sources of positioning, measures positioning signals/sources (based on assistance information from NW). Finally, the UE returns measurements to the network, and the network computes the device position (at the location server/LMF). See TS 38.305.

NR DL Positioning Reference Signals

More recently, 3GPP has defined enhanced positioning protocols, new positioning techniques, and New Radio (NR)-based Positioning Reference Signals (PRS) in Rel-16. The NR PRS is loosely based on the LTE pseudo-random sequences and is specified in TS 38.211. The updated NR PRS further improves “hear-ability” of the PRS from neighbor cells. This yields an improved positioning accuracy, but it is dependent on network deployment (e.g., density of gNBs/TRPs), RF conditions, and PRS configuration parameters, such as bandwidth, periodicity and muting patterns as discussed further.

DL-TDOA (DL Time Difference of Arrival) is one such method that leverages a PRS transmission broadcast from an NG-RAN node. UE performs downlink reference signal time difference (DL-RSTD) measurements for each gNB/TRP PRS(s), and optionally DL-PRS-RSRP. These measurements are reported to the LMF (Location Management Function/Location Server) in the case of UE-A. For UE-B, the UE calculates and reports its position to the network.

Another DL technique that leverages broadcast PRS is the AoD (Angle-of-Departure) method. The UE measures the PRS reference signal receive power (DL RSRP) per beam/gNB. Measurement reports are used to determine the AoD based on UE beam location for each gNB. For UE-A, the LMF then uses the AoDs to estimate the UE position or for UE-B, the UE calculates and reports its position to the network.

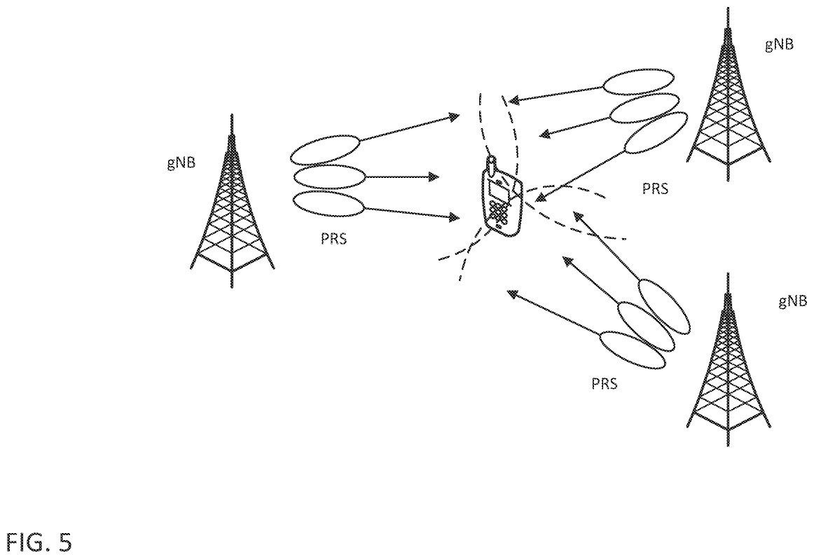

These multi-lateration techniques depicted in FIG. 5 are well known and established methods for locating UEs. Geometrically, UE location is derived from each time/range difference (RSTD). Typically, a minimum of 3 gNB (geo-dispersed) measurements are required for reliable position relative to UE internal timing. This also requires a serving (reference) cell as well as timing/RSRP measurements from neighbor cells.

Location of TRPs and assistance data (configuration/resource information) can be delivered over the Uu interface either broadcast in positioning System Information Blocks (posSIBs) and/or in NAS signaling via LPP messages in RRC_CONNECTED.

DL PRS Configuration Techniques

The IE NR-DL-PRS-Info defines downlink PRS configuration, which is sent from the network (e.g., LMF) to the UE as defined in TS 37.355 (LPP). This assists the UE in reception of PRS transmissions from serving and neighbor cells. See the Abstract Syntax Notation One (ASN.1) example of Appendix Item 1 and the NR-DL-PRS-Info field descriptions of Appendix Item 2.

The PRS transmission configuration information and assistance data (e.g., NR-DL-PRS-Info) enable a UE to detect and measure positioning reference signals and either calculate UE position or send measurements to the network for calculation. Typically, this information is delivered to the UE in a P2P (Point-to-Point) manner in RRC connected mode via NAS (LPP) signaling.

Another alternative for a UE to receive PRS-related IEs is via positioning System Information Blocks (posSIBs). The posSIBs contain positioning assistance data associated with a number of positioning technologies including, PRS-related methods such as DL TDOA, DL-AOD and multi-RTT.

The procedures for posSIB acquisition leverage the same procedures as other SIBs (e.g., SIB2, SIB, etc.) For example, SIB1 contains scheduling information (PosSchedulingInfo-r16) associated with the posSIBs. These SIBs are mapped to the BCCH and is either broadcast periodically on DL-SCH or broadcast on-demand on DL-SCH (upon request from UEs in RRC_IDLE or RRC_INACTIVE) or sent in a dedicated manner on DL-SCH to UEs in RRC_CONNECTED.

The IEs that are broadcast in the posSIBs are the same as those defined in LPP. Within 38.331, RRC, PosSystemInformation-r16-IEs maps to positioning SIB type (posSibType) where detailed AD IEs are defined in LPP.

Some of the Relevant IEs for PRS related positioning methods are defined in TS 37.355 clauses 6.4.3, 7.4.2 and then mapped to the following posSIBTypes in RRC: See the table of Appendix Item 3.

TR 38.857 Conclusions

The Study on NR Positioning Enhancements concluded a number of enhancements over the existing Rel-16 NR positioning mechanisms. Namely, these general issues with the current PRS definition were identified. See TR 38.857.

Efficiency: PRS uses revenue generating BW, potentially adds interference.

NR PRS has unnecessary overhead and a waste of resources in the case where no UE positioning is required during a particular time or in a particular coverage area of a network. If supported, DL PRS is always broadcast from gNB. In case of beamformed DL-PRS, DL-PRS transmission in all beam sweeping directions can result in an unnecessary transmission of DL-PRSs. Temporary changes in the DL-PRS configuration/resources for meeting higher positioning accuracy and/or lower latency positioning requirements in certain areas or at certain times is suggested.

Accuracy: DL-PRS configuration may not be sufficient to meet the accuracy requirements of the LCS client; e.g., may have a too small bandwidth, too few repetitions, etc. as it is statically configured from an LMF. Network deployment and RF conditions are factors impacting confidence/uncertainty in position.

Latency: DL-PRS configuration may not be sufficient to meet the response time requirements of the LCS client, e.g., may have a too large periodicity, which is a static configuration parameter.

Finally, it is necessary to manage tradeoffs between efficiency, accuracy & latency both from UE and network perspective.

With these issues in mind, in TR 38.857 Rel-17, from an upper layer perspective, the following three approaches to on-demand PRS functionality may be used. First is UE-initiated request of on-demand DL-PRS transmission. Second is LMF-initiated on-demand control of DL-PRS transmission. Third, is that the dynamic changing of parameters, measurements, and/or assistance information for LMF/UE initiated on demand PRS.

UL Data Transfer Optimizations

Positioning protocols generally require frequent transmission of small UL messages. A problem arises since NR supports data transmission in RRC_CONNECTED state only. It means that positioning related UL data transmission requires frequent transitions between RRC states which consumes energy and introduces signalling overhead.

Recently, 3GPP has started a work item to address the problem of energy consumption and signalling overhead caused by small data. The improvement is referred to as Small Data Transmission (SDT) where the main principle is to keep such UEs that have need for frequent transmission of small UL data in RRC_INACTIVE state and allow UL transmission of small data in RRC_INACTIVE state. In that way, frequent RRC state transitions are avoided, and energy consumption and overhead problems are alleviated. The details of SDT are still subject for discussion but they are expected to be based on similar kind of concepts as Early Data Transmission (EDT) features and cellular IoT optimizations in LTE.

Envisioned use cases for NR SDT include procedures typically associated with existing positioning protocols, e.g., transfer of measurements and assistance data.

Example Challenges

Issue 1A: How UE Triggers, Obtains, and Assists the Network in Modifying DL PRS Resources for Appropriate PRS Resource Allocation

As part of the Rel-17 Study Item on NR Positioning Enhancements, RAN2 has agreed to the following: “UE-initiated request of on-demand DL-PRS transmission is recommended for normative work; the details will be decided during WI phase.”

The existing UE positioning procedures and mechanisms as described in Release 16, leverage static resources for PRS transmissions. This can result in less efficient use of network resources as DL PRS transmissions are broadcast from gNB in the absence of LCS/positioning procedures. Additionally, PRS resources and configuration may require modification to meet a higher demand for accuracy and latency requirements.

Impacts to other nearby UEs must also be identified and mitigated when the network changes the configuration of PRS transmissions (e.g., intercell interference).

Issue 1B: How does a Network (GNB, LMF) Evaluate and Modify DL PRS Configuration and Resources for Appropriate PRS Resource Allocation for One or More UES

As part of the Rel-17 Study Item on NR Positioning Enhancements, RAN2 has agreed to the following: “LMF Initiated on-demand control of DL-PRS transmission is recommended for normative work; the details will be decided during WI phase.”

Existing LMF positioning procedures and mechanisms utilize static configurations for PRS transmissions. This can result in less efficient use of network resources as DL PRS transmissions are broadcast in the absence of LCS/positioning procedures. Additionally, PRS resources and configuration may require modification to meet accuracy and latency requirements for one or more UEs or group of UEs and possibly TRPs/gNBs. The LMF/Network needs to have certain criteria, evaluation, and procedures to initiate a modification to PRS transmission configuration and resources.

Issue 2: How to Minimize Latency in the Positioning Procedures Associated with PRS-Related Techniques

As part of the Rel-17 Study Item on NR Positioning Enhancements, RAN2 has agreed to the following: “enhancements of signaling & procedures for reducing NR positioning latency are recommended for normative work, including DL and DL+UL positioning methods.”

The existing Rel-16 NR positioning procedures incur latency associated with the reception of DL PRS, measurements and the reporting and request of measurements, and the request and delivery of network assistance data. This latency may be further increased by the introduction of non-persistent PRS transmissions by gNB/TRPs and PRS (re)configuration procedures.

Issue 3: How to Identify and Mitigate PRS Error Sources to Enhance Integrity of the Positioning Calculation and or Measurements

The existing Rel-16 NR positioning procedures do not sufficiently address identification of error sources and integrity (trustworthiness) of PRS reception. This can lead to an increase in uncertainty/confidence KPIs associated with PRS-related measurements and positioning calculations. Error sources may include RF conditions, such as NLOS (Non-Line of Sight) and multi-path, as well as intercell PRS interference. Identification and subsequent mitigation of these error sources can improve location accuracy, latency, and reliability.

Issue 4: How to Identify Cells where SDT is Supported

The existing 3GPP radio interface standardization methodology assumes that the network has full knowledge of the UE capabilities. It is a pre-requisite for the RRC configuration of UEs, and the main mechanism to ensure interoperability and mobility in RRC_CONNECTED state.

The situation is different for SDT procedures in RRC_INACTIVE state because the transmitting entity (UE) does not know the capabilities of the receiving entity (radio access network node). If the UE triggers UL data transmission in RRC_INACTIVE state but the cell does not implement SDT feature, the procedure will fail because the network cannot receive the data. This may happen after cell selection and re-selection procedures which are the only mobility procedures in RRC_INACTIVE state.

It is worth emphasizing the assumption that all networks will always support SDT procedures in all cells is not practical for many reasons. It depends on network deployments, operators' preferences, and how quickly network equipment vendors introduce new features.

A real-life network deployment normally has a mixture of different vendors' equipment and all vendors do not roll out software updates and new features at the same time. In general, upgrade of nodes in a large network (tens of thousands of nodes) can take several weeks even if the operator has only one vendors' equipment. It is also typical that some of the old network nodes cannot be upgraded to support latest features or software updates due to hardware limitations. Therefore, real-life network deployments may have boundary areas where neighboring cells support different sets of features.

In addition, SDT procedures in RRC_INACTIVE state cannot guarantee the same level of UL data security as RRC_CONNECTED state. These security aspects may impact operators' decisions whether or not to deploy SDT and if so, where and when to deploy it.

Example Solutions

Example Solutions for Issue 1A

To increase the positioning accuracy and efficiency of positioning reference signals, the existing positioning procedures, and architecture to support UE requests to modify one or more serving and/or neighbor TRPs may be enhanced. The details of these enhanced procedures are further described to realize these potential benefits.

To further illustrate the procedures, the following one or more steps apply. As an initial step, a UE with PRS and associated positioning calculation method (RSTD, TDOA, multi-RTT, AoD, etc.) capabilities, should be provisioned with some pre-conditions for UE triggers or criteria for evaluation of PRS-based positioning (re)configuration. This may be done in advance, stored in some persistent or semi-persistent memory (either volatile or non-volatile memory/data structure stored on UE), or configured over the air by the network. This provision of UE triggers for evaluation of PRS resources/configuration can be based on an event (periodic measurement(s), event-based trigger, etc.) and a parameter set (e.g., Request Config Allowed) to enable or disable positioning reconfiguration requests and criteria evaluations. Event-based triggers may be a number of UE actions, such as a location request, cell (re)selection, detection of a positioning signal, emergency calling, or combination of an event and positioning measurement(s).

The validity of the evaluation trigger may be granular for a specific gNB, TRP or beam, or of wider granularity, e.g., PLMN, TA, RNA, etc. Furthermore, the UE trigger(s) may be pre-configured by a network source, e.g., gNB, TRP, LMF or location server. In addition, the validity may also have a time (timer) aspect associated with the evaluation trigger.

Once the UE has identified that a trigger for PRS evaluation criterion has been met, the UE evaluates the existing (initial/first) PRS resources and configuration, based on one or more of the following: Positioning KPIs (e.g., QoS, positioning accuracy, positioning latency, inter-cell interference), current PRS configuration, including a Request Config Allowed for a particular UE, a Request Config Allowed for a particular gNB/network resource, as well as other UEs nearby or in a vicinity. Note that further embodiments of a Request Config Allowed, may include other aspects, such as frequency of Request Config Allowed (e.g., counter/given time, number of UE requests allowed), or allowed requests only for certain services (e.g., emergency services).

Additionally, UE measurements (e.g., PRS, SSB, NLOS/LOS, multipath detection) of serving and neighboring gNBs may be a part of the evaluation process.

If the UE identifies that the criteria for a PRS transmission/resource request has been met, the UE generates and transmits a PRS transmission request (in RRC connected, inactive, or idle mode), including one or more of the following parameters nine items.

First is a configuration of limits of frequency of (re)configuration of requests or only under certain circumstances (e.g., 911). Second is coarse location. Third is UE capabilities. Fourth is a PRS measurement set, PRS transmission configuration parameters, and/or PRS resource identifiers. Fifth are other positioning measurements such as cell-edge and mobility measures. Sixth is an urgency indicator, e.g., an indication if the PRS reconfiguration is urgent or degrees/levels of urgency. Seventh is a time delay or time window. For example, an indication that the UE requires the new PRS reconfiguration within K msec or within a time range. Eighth is a relative priority associated with more than one PRS (re)configuration request. The network may receive multiple PRS configuration requests. This would enable the network/LMF to prioritize which is more important. Ninth is a time schedule indication that the UE needs the new PRS configuration(s) based on a provided schedule.

The UE PRS transmission requests are received by the network and a response is generated from the network. In one embodiment, this request is received by a gNB or NG-RAN node. In other embodiments, the request is received by a location server, LMF or other network entity. This request is then processed by the network, then one or more responses are sent to one or more UEs, e.g., either the UE(s) making the request and/or nearby UEs in the vicinity.

The processing of the request by the network may include an update of one or more gNB PRS configuration set (group of configurations) or resources including Off/On, High/Low resources and bandwidth, muting pattern, emergency configuration, etc.

The processing of the request by the network may include a grant, a partial grant (e.g., only grant one or more PRS config parameters, or only a portion of the requested resources), or denying PRS (re)configuration by modifying one or more of the following seven messages and procedures: LPP ProvideAssistanceData; new configuration set(s)/group, validity period for the new configuration; LPP RequestLocationInformation; prioritize newly configured TRPs for measurements; broadcast SI update: posSIB(s); update other UEs in serving/neighbor cells of TRP/gNB (re)configurations; in case of denial of PRS transmission request, receiving notification for fallback behavior, e.g., new positioning method (GNSS, Enhanced-Cell-ID, etc.).

In the event that the LMF denies a UE request for PRS transmission reconfiguration, the LMF may configure other positioning sources, methods, and signals to meet the positioning KPI/requirements. For example, the response received by the UE, could include configuration for leveraging other positioning signals, e.g., SSB measurements, CSI-RS measurements, or other PRS measurements, UL methods that leverage SRS (Sounding Reference Signal), depending on the capabilities of the UE and system.

In alternative embodiments, the network (e.g., LMF) may configure one or more UE with a set of PRS resources (e.g., BW) with full or partial inactivation of the resources at any given time. Additionally, the UE may be made aware via SI or dedicated signaling, that the serving or neighbor cell(s) have multiple available PRS resource sets that may be activated upon request. The UE could then also use access stratum signaling to request to the gNB which PRS resource set to activate/deactivate.

Subsequently, the LMF may then configure the UE via one of the following six methods. First is RRC messages to activate a set or subset of PRS resources via dedicated signaling or through system information. Second is LPP messages to activate a set or subset of PRS resources. Third is to use MAC-CE to activate a set or subset of PRS resources that the UE should use for measurement/measurement reporting. Fourth is to use DCI to activate the set or subset of PRS resources that the UE should use for measurement/measurement reporting. Fifth is RRC with a combination of above methods (MAC-CE and/or DCI) for activation and indication of a set or subset of PRS resources to use. Sixth is to activate more than one set/subset by MAC-CE, and subsequently use a DCI to dynamically indicate to the UE when and which PRS resource set(s) or subset(s) to use for positioning calculation, and the PRS resource set(s) or subset(s) to utilize for measurements and report to the network.

Note that in an exemplary solution, the existing DCI formats as specified in TS 38.212 (7.3 Downlink control information) could be leveraged with updated field(s) and/or bitmap to specify (de)activation. Alternatively, a new DCI Format could be specified for NR Positioning procedures.

Similarly, PRS resource set or subset de-activation may be triggered by the LMF via RRC, LPP, MAC CE, and/or DCI to deactivate the set or subset of PRS resources that the UE can use for positioning procedures. An exemplary set of MAC-CE values of LCID for DL-SCH is shown as follows:

Based on TS 38.321 section 6.2.1, an example value for PRS resource activation/deactivation is given. Note that the contents of the MAC CE may contain an identifier to allow the UE to determine which of the PRS resource sets to activate (or de-activate). See appendix item 8, which is a table of values of LCID for DL-SCH.

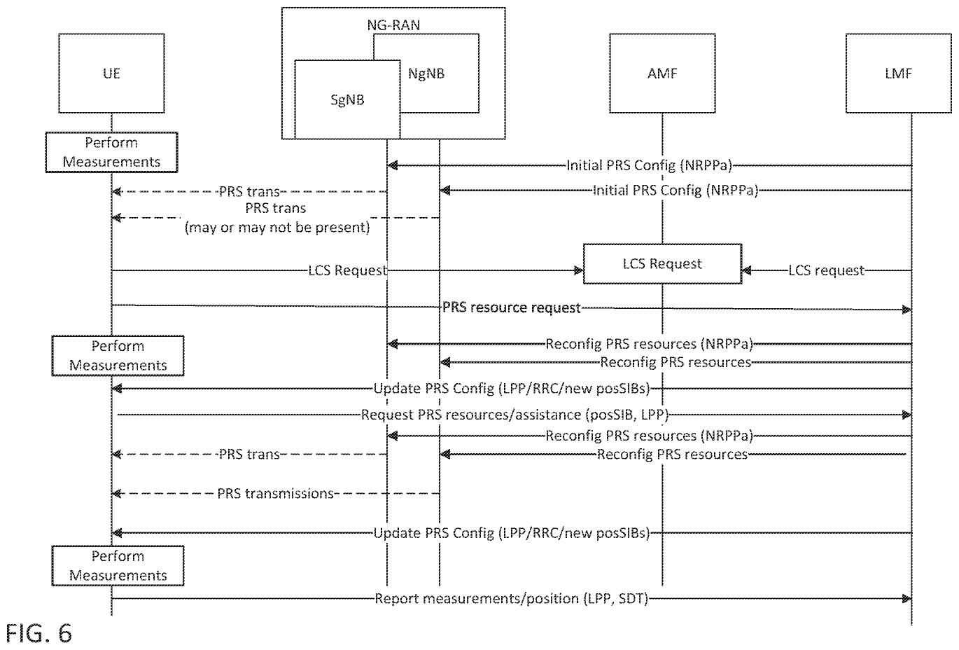

To further illustrate these procedures, the message flow in FIG. 6, whereby aa UE requests a reference signal reconfiguration.

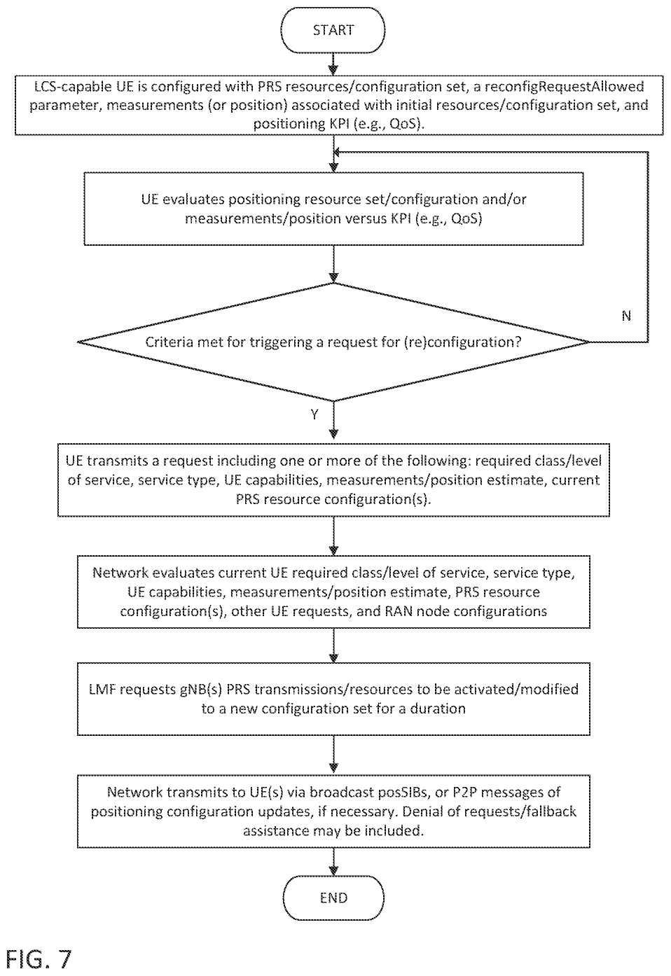

Once the PRS and positioning (re)configuration has been updated from the network perspective, the UE receives via broadcast SI or a P2P positioning protocol and processes the (re)configuration. From this new information and configuration, the UE may perform positioning measurements and either calculate UE location (UE-B) or report measurements for network computation of UE location (UE-A). An exemplary process flow is shown in FIG. 7.

In one example, the UE may be configured via Information Elements (IEs) that are embedded as part of the existing LPP messaging construct. The exemplary IEs as shown in the following common PRS LPP Provide Assistance Data, enables UE evaluation to request PRS (re)configurations based on one or more criteria, triggers, threshold(s), measurements, or the like, or combination of them.

TS 37.355 Section 6.4.3

NR-DL-PRS-ASSISTANCEDATA

The IE NR-DL-PRS-Assistance Data is used by the location server to provide DL-PRS assistance data. The location server should include at least one TRP for which the SFN can be obtained by the target device, e.g., the serving TRP. The nr-DL-PRS-ReferenceInfo defines the “assistance data reference” TRP whose DL-PRS configuration is included in nr-DL-PRS-AssistanceDataList. The nr-DL-PRS-SFN0-Offset's and nr-DL-PRS-expectedRSTD's in nr-DL-PRS-AssistanceDataList are provided relative to the “assistance data reference” TRP. The network signals a value of zero for the nr-DL-PRS-SFN0-Offset, nr-DL-PRS-expectedRSTD, and nr-DL-PRS-expectedRSTD-uncertainty of the “assistance data reference” TRP in nr-DL-PRS-AssistanceDataList.

For NR DL-TDOA positioning (see clause 6.5.10) the nr-DL-PRS-ReferenceInfo defines also the requested “RSTD reference”. See Appendix item 9 for an Abstract Syntax Notation One (ASN.1) example, and Appendix Item 10, NR-DL-PRS-Assistance Data field descriptions.

Alternatively, these IEs may be broadcast from gNB(s) to UEs within positioning SIBs. Furthermore, the UE enablement for request of UE initiated PRS (re)configuration, may be included in the LPP Request Location Information and associated IEs (shown in bold), similar to LMF messages sent to the UE in NR Provide Assistance Data messages as previously discussed. Note that in the following example, request location information is shown as part of the TDOA method, but similar IEs could be envisioned for other methods that leverage PRS(s) such as RTT and AoD.

NR-DL-TDOA-REQUESTLOCATIONINFORMATION

The IE NR-DL-TDOA-RequestLocationInformation is used by the location server to request NR DL-TDOA location measurements from a target device. See Appendix Item 11 for an Abstract Syntax Notation One (ASN.1) example, and Appendix Item 12 NR-DL-TDOA-RequestLocationInformation field descriptions. See TS 37.355 section 6.5.10.5.

As previously described, the UE may request PRS transmission (re)configuration based on satisfying preconditions. If allowed and the evaluation criteria has been met for the UE to send a request (and associated information with the request), this may be done via an existing LPP message with newly configured IEs. In one example, the LPP Request Assistance Data could include an IE for the UE to request an LMF to (re)configure PRS transmissions as shown here for TDOA techniques, but could be similarly updated for e.g., AoD, RTT, etc.

NR-DL-TDOA-REQUESTASSISTANCEDATA

The IE NR-DL-TDOA-RequestAssistance Data is used by the target device to request assistance data from a location server. See Appendix Item 13 for an Abstract Syntax Notation One (ASN.1) example, and Appendix Item 14, NR-DL-TDOA-RequestAssistanceData field descriptions. See TS 37.355 section 6.5.10.2.

In alternative embodiments, the UE may require some measurements to determine or calculate the need for a request for modification by the network of the PRS transmissions for serving or neighboring cells. As part of the LPP Provide Location Information IEs, the UE may also include general or specific requests for modifications of PRS transmissions as shown.

NR-DL-TDOA-PROVIDELOCATIONINFORMATION

The IE NR-DL-TDOA-Provide LocationInformation is used by the target device to provide NR DL-TDOA location measurements to the location server. It may also be used to provide NR DL-TDOA positioning specific error reason. See Appendix Item 19 for an Abstract Syntax Notation One (ASN.1) example, and Appendix item 20, NR-DL-TDOA-ProvideLocationInformation field descriptions. See TS 37.355 section 6.5.10.3.

In response to the aforementioned Provide Location Information and associated PRS transmission request, the network may respond with an LPP Provide Assistance Data to inform the UE of the change in PRS transmissions of one or more PRS resources and direct the UE to obtain new measurements. Alternately, denial of PRS request message with other fallback positioning methods or resources may be sent by the network. The network my toggle the dl-PRS-ConfigRqstAllowed for denial of PRS (re)configuration request.

Example Solutions for Issue 1B

To increase the positioning accuracy and efficiency of positioning reference signals, the existing positioning procedures, and architecture to support LMF initiation for modification of one or more serving and/or neighbor TRPs may be enhanced. The details of these enhanced procedures are further described herein to realize these potential benefits.

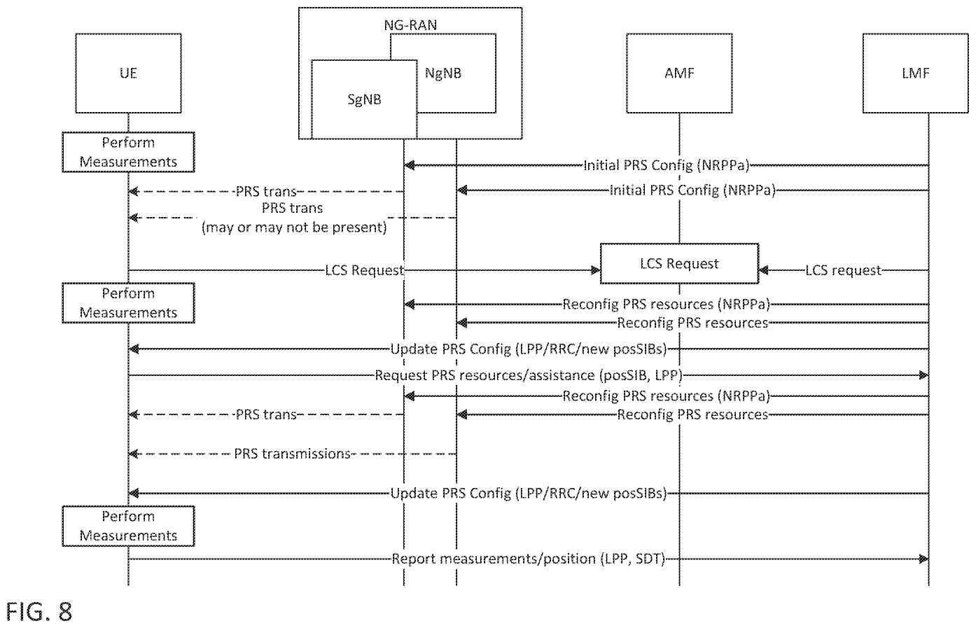

To further illustrate the procedures, the following one or more steps based on LPP and related protocols, as shown in FIG. 8. It should be noted, that the LPP and NRPPa messages need not be performed sequentially as shown in the FIG. 8. This flow shown in FIG. 8, although similar to the UE-initiated case, the LMF/network must evaluate the resources and requirements associated with multiple UEs within the coverage of the serving and neighbor cells.

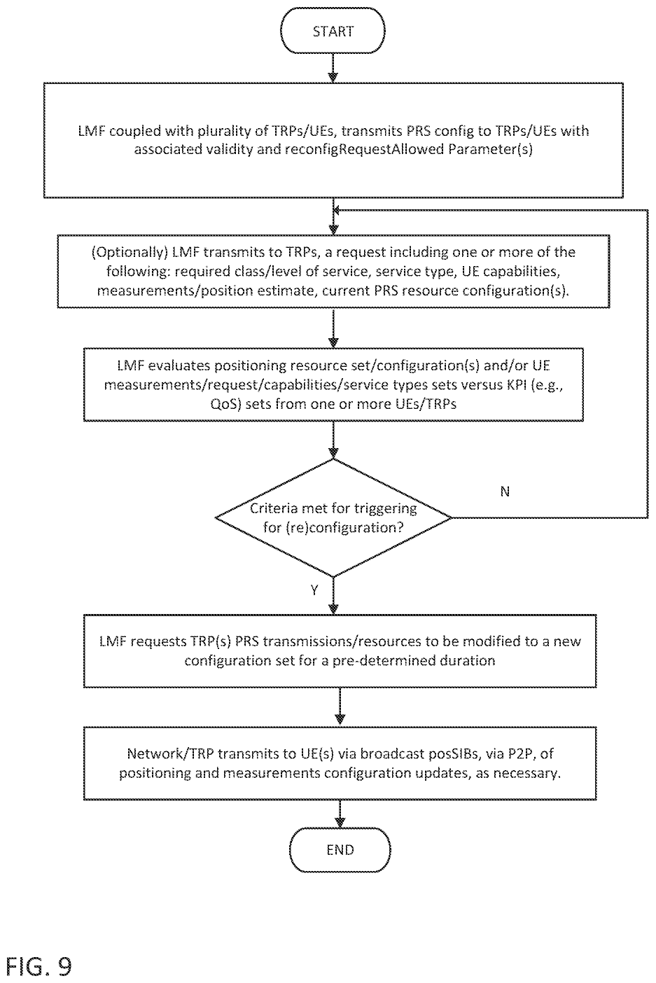

The evaluation and criteria for triggering PRS transmission configuration for LMF-initiated methods, the following process flow, which could also be used in conjunction with UE-initiated methods may be used. In the case where both UE-initiated and LMF-initiated PRS transmission configuration is enabled; any conflicts must be reconciled by the network as multiple UEs may request reconfiguration from an LMF. See FIG. 9.

In this process, an LMF-based (location server/network) solution may be used, whereby an LMF is operatively coupled with one or more TRPs and UEs. The LMF may initially transmit PRS configurations (including PRS disabled) to TRPs and UEs associated with a validity and reconfigRequestAllowed parameters. Optionally, the LMF may transmit to TRPs, a request, including one or more of the following: required class/level of service, service type, UE capabilities, measurements/position estimate, current PRS resource configuration(s). This process may also require some acknowledgement from the TRP.

Next, the LMF evaluates positioning resource set(s), current PRS configuration(s) and/or UE characteristics, including, but not limited to measurements, sets of measurements, gNB measurements, e.g., SRS transmitted by UE(s), (re)configuration requests, UE(s) capabilities, service types sets, and versus minimum KPI (e.g., QoS) sets from one or more UEs/TRPs.

Then, the LMF must evaluate whether or not criteria have been met for triggering for positioning and PRS (re)configuration. If the triggering criteria has been met, the LMF requests TRP(s) PRS transmissions/resources to be modified to a new configuration set for a pre-determined or configurable duration. If the triggering criteria has not been met, the LMF can wait for the next opportunity to re-evaluate the criteria for triggering (re)configuration. Note that the criteria may be partially fulfilled and trigger a partial reconfiguration or update to be initiated. This (re)configuration process may also require some acknowledgement from the TRP.

Finally, the network/TRP transmits to UE(s) via broadcast posSIBs, via P2P, or other means, of positioning and measurements configuration updates, as necessary.

Example Solutions for Issue 2

Possible Acquisition and PRS Reception

Leveraging LPP messaging for PRS (re)configurations and negotiation may add additional latency. A method to reduce latency suggests that the UE is to request modifications to PRS transmissions by utilizing procedures for requesting other SI (on-demand SI). PosSIBs may not be typically broadcast to reduce unnecessary overhead in the cell by transmitting posSIBs only when explicitly requested by UE (avoid broadcast when no UEs are present). Corresponding to this, if PRS transmissions are currently not broadcast the related PosSIBs would not be broadcast as well.

In this example, the existing procedure for a UE request of On-demand posSIBs may be used as a trigger for the network (gNB, LMF) to activate or modify one or more TRP PRS transmissions and/or reconfigure existing transmissions.

For UEs in RRC_IDLE and RRC_INACTIVE, a request for Other SI triggers a Random Access (RACH) procedure. This is determined by the UE after reading SI scheduling information from SIB1. From this, the UE can determine broadcast status (via si-BroadcastStatus) of a posSIB associated with PRS. This field indicates if one or more posSIBs within the SI-message are being broadcast or not. If si-BroadcastStatus is set to ‘broadcasting,’ the UE would acquire the concerned posSIB(s) ‘normally.’ This could also be an implicit indication that PRS transmission reconfiguration requests are not possible.

However, if si-BroadcastStatus is set to ‘not broadcasting,’ the UE would proceed with RACH procedure to acquire those posSIB(s). For this procedure, if the network configures the UE with resources for the posSIB request, this can also be an implicit trigger to activate or modify one or more TRP PRS transmissions. As part of this procedure, additional embodiments may include a UE, to be configured by the network, with dedicated or reserved RACH resources for PRS configuration. This may be specific to RACH frequency or time domain resources and can be used as an implicit indication of a PRS resource request set or subset (in the case of pre-configuration activation). Furthermore, a reserved set of RACH preambles could be used by the UE as another implicit mechanism to indicate a request for PRS configuration update, or a specific PRS configuration update. In case of 2-step RACH, in Message A, dedicated or reserved PUSCH resources in time, frequency or both may be used by the UE as an implicit indication of a PRS resource request or request for PRS configuration update or the like. Furthermore, dedicated or reserved DMRS ports and/or sequences may also be used by the UE as an implicit indication of a PRS resource request or request for PRS configuration update. PUSCH resources in time and/or frequency as well as DMRS ports and/or sequences may be used jointly for implicit indication of a PRS resource request, request for PRS configuration update or the like.

Another embodiment may involve an explicit indication with the request carrying an IE that requests PRS configuration update. For both the implicit and explicit cases, the request(s) and associated information is conveyed from the gNB to LMF via NRPPa or other network protocol. However, for UE in RRC_IDLE, there is no context in gNB for a specific UE. This requires the gNB to address a UE request via one or more RNTI (or Pos-RNTI) and the LMF can associate the RNTI with the positioning procedures. For RRC_INACTIVE, there is a context, and the UE can be specifically identified in network (e.g., NRPPa) procedures.

In any of the cases, a benefit of these procedures is that the UE is not required to transition to RRC_CONNECTED state, thus reducing latency associated with the procedures.

Alternatively, for a UE in RRC_CONNECTED, the network can provide posSIB updates through dedicated signaling using the RRCReconfiguration message in the case that PRS transmission (re)configuration has occurred. See 3GPP TS 38.331. This may introduce additional latency.

The network can provide posSIB updates through dedicated paging messages over short message bit field as shown in the following examples.

One or more UE receive notification of PRS resource configuration updates as part of a paging notification, further comprising
i. request to the UE to calculate and/or report its position, or
ii. request to the UE to report positioning related measurements

Using TS 38.331 section 6.5 as a baseline, the following highlights an example of possible bit indication, which is dependent on the configured positioning mode (i.e., UE-based, UE-assisted) of the UE.

Short Messages can be transmitted on PDCCH using P-RNTI with or without associated Paging message using Short Message field in DCI format 1_0 (see TS 38.212, clause 7.3.1.2.1).

Appendix Item 17 is a table of short messages, wherein bit 1 is the most significant bit.

From an RRC perspective, acquisition and request of on-demand PosSIB can be enhanced as shown in bold as changes to the standard in Appendix Item 18.

Enhancements to PRS Reception Latency Reduction

Additional enhancements to PRS reception reconfiguration may be used to further reduce latency. As part of the UE procedures with reconfigRequestAllowed parameter set, including measurements of a first PRS configuration, the UE may require additional and/or prioritized measurements depending upon whether or not PRS reception reconfiguration takes place. For example, a UE can be configured for reporting measurements as part of a PRS reconfiguration request associated with the first PRS configuration, allowing subsequent UE-assisted measurement reports to be sent by the UE and later concatenated by the network for positioning determination.

In additional embodiments, a UE receiving, as part of a second PRS transmission resource and configuration set, PRS reception, and PRS measurement prioritization for the newly configured TRPs. This will aid in reducing latency associated with the first and second PRS configurations.

As part of a second PRS transmission resource and (re)configuration set, include configuration associated with reporting additional PRS measurements based on the reconfiguration, in RRC_IDLE/INACTIVE, via methods such as Small Data Transmission (SDT), MAC-CE, or CG-based transmission. This would also reduce latency involved in typical measurement reporting methods leveraging LPP or user plane (SUPL) done in RRC Connected mode.

An enhancement for UE and/or gNB to be configured with a plurality of PRS reception configurations may comprise one or more of the following: grouping multiple sets of parameters into configuration sets/levels at UE or gNB; validity associated with each group of configurations; semi-persistent or persistent PRS transmission configuration(s) stored and quickly accessed/activated; and PRS reception configuration sets and/or “Request Config Allowed” only for certain device types or characteristics, e.g., REDCAP, non-mobile UEs.

Methods may allow for PRS reception (re)configuration procedures to occur as part of other positioning procedures and may not be associated with a specific LCS request to further reduce latency.

Example Solutions for Issue 3

Positioning accuracy, latency and integrity is based on a number of factors such as TRP/network well geo-dispersed deployment (e.g., density of gNBs/TRPs), RF conditions, and PRS configuration. To increase positioning KPIs, methods and system for a first device to identify and mitigate error sources related to discontinuous PRS transmissions as previously described may be used. These methods may comprise of one or more of the following.

First is the UE transmitting to the network in PRS transmission measurement report(s) and/or UE PRS reconfiguration requests, which includes one or more of the following detected error sources and quantitative measures. Second is multi-path and LOS/NLOS Identification for serving and neighbor cells. Third is insufficient number of TRPs/gNBs for PRS-related positioning calculations, e.g., RTT, TDOA, AoD. Fourth is PRS intercell interference as increased PRS transmit power improves hear-ability and accuracy but may increase possibility of interference with neighbor cells.

Fifth is the UE, receiving from the network, a PRS measurement and associated positioning calculation error source reporting configuration, comprising: threshold(s) of acceptable and/or unacceptable levels of interference; threshold(s) for delay spreads as a result of multipath associated with the PRS signals; threshold(s) for the number of TRPs without LoS or identification of NLoS/LOS; an associated prohibit timer related to the error source reporting and avoid excessive number of reports; threshold(s) for angle spreads as a result of beamforming associated with the PRS signals; and thresholds for transmit and receiver timing errors.

The Network (gNB, LMF) upon reception of PRS transmission measurement report(s) and/or UE PRS reconfiguration requests identifies associated error sources and initiates one or more of the following. First is re-allocation of PRS transmission resources and update PRS configurations considering potential for interference. Second is to activate/update muting patterns for serving and/or neighbor cells. Third is use as an input to determine/calculate confidence and uncertainty of position/measurements. Fourth is to trigger for UE-initiated PRS request allowed and evaluation. Fifth is to configure UE to use other fallback positioning methods. Sixth is to require validation of measurements and position determination with other positioning technologies/methods.

Identification of Cells where SDT Procedure May be Triggered

Method and system for a network node indicating support of SDT procedure in a cell by using system information broadcast to transfer an SDT indicator with the following components:

The SDT indicator has a presence bit where setting presence value of the SDT indicator to value ‘present’ in a cell where SDT capable UE can trigger an SDT procedure. Setting presence value of the SDT indicator to value ‘absent’ in a cell where SDT capable UE is prohibited to trigger SDT procedure.

Apart from the presence bit, the SDT indicator may have two possible values where value ‘allowed’ indicates that SDT procedures are allowed in the cell and ‘not allowed’ indicates that SDT procedures are prohibited or temporarily barred

Method and system for a SDT capable UE triggering UL transmission of data:

Reading SDT indicator from a system information block to acquire information whether SDT procedure is supported in the cell or not:

If the indicator is composed of a presence bit only:

Interpreting presence of an SDT indicator as allowed SDT procedure in the cell

Interpreting absence of SDT indicator and omitted SDT indicator as prohibited SDT procedure in the cell

If the indicator carries ‘allowed’ and ‘not allowed’ values

Interpreting presence of an SDT indicator with value ‘allowed’ as allowed SDT procedure in the cell

Interpreting presence of an SDT indicator with value ‘not allowed’ as prohibited or barred SDT procedure in the cell

Interpreting absence of an SDT indicator or omitted SDT indicator as prohibited SDT procedure in the cell

Method and system for a UE performing reselection:

Reading SDT indicator from a system information block to acquire information whether SDT procedure is supported in the new cell or not

If the indicator is composed of a presence bit only, interpreting presence of SDT indicator as allowed SDT procedure after cell reselection. If the indicator carries indication values, interpreting presence of an SDT indicator with value ‘allowed’ as allowed SDT procedure after cell re-selection.

If the indicator is composed of a presence bit only, interpreting absence of SDT indicator and omitted SDT indicator as prohibited SDT procedure. If the indicator carries indication values, interpreting presence of SDT indicator with value ‘not allowed’ as prohibited or barred SDT procedure after cell reselection.

Completing SDT procedure initiated in the source cell before executing cell reselection to the new cell, or

Interrupting SDT procedure initiated in the source cell and executing cell reselection to the new cell, or

Requesting RRC Connection, transitioning to RRC_CONNECTED state and interrupting SDT procedure

Method and system for a UE indicating positioning data as SDT:

Setting a data type indicator bit to indicate that the small data conveys control plane related positioning data and must be forwarded to LMF, or

Containing separate messages for different type of small data whereof one type is 1) user plane data or user plane related positioning data and 2) the other type is control plane related positioning data, allowing both small data types transmitted at the same time.

Containing separate messages for different type of small data whereof one type is 1) user plane data, 2) user plane related positioning data and 3) the other type is control plane related positioning data, allowing potentially all small data types transmitted at the same time.

Method and system for AMF receiving forwarded small data from radio access network:
Interpreting the value of the small data type indicator and forwarding control plane related positioning data to LMF, or
In the case of separate messages for two different type of small data, forwarding contained control plane related positioning small data to LMF and the rest of the small data to UPF

In the case of separate messages for three different type of small data, forwarding contained control plane related positioning small data to LMF and the rest of the small data to UPF

For any of the above actions, the LMF may also transmit an update/reconfigure a plurality of UEs within an area or vicinity via P2P or broadcast signaling.

This would require additional IEs for both a first UE to transmit error detection and associated KPIs, as well as IEs for a network entity to transmit notification and/or mitigation for these error sources. From the UE perspective, this could be accomplished in a measurement report (e.g., LPP Provide Location Information) and/or as part of a PRS transmission reconfiguration request.

An exemplary IE structure is shown as part of the LPP provide location information message but may also be included as part of other messages (e.g., LPP, SUPL or dedicated error messages) transmitted from the UE to the network. These specification updates may also be leveraged for other positioning methods that utilize PRS transmissions or other positioning technologies.

Baseline from TS37.355 sec 6.5.10.3

NR-DL-TDOA-PROVIDELOCATIONINFORMATION (WITH ERROR MITIGATION INFO REQUEST)

The IE NR-DL-TDOA-Provide LocationInformation is used by the target device to provide NR DL-TDOA location measurements to the location server. It may also be used to provide NR DL-TDOA positioning specific error(s) and error measures. See the Abstract Syntax Notation One (ASN.1) example in Appendix Item 15, and Appendix Item 16, NR-DL-TDOA-ProvideLocationInformation field descriptions.

UE detected error sources may also be included in the existing Error IE construct per LPP.

NR-DL-TDOA-TARGETDEVICEERRORCAUSES

The IE NR-DL-TDOA-TargetDeviceErrorCauses is used by the target device to provide NR DL-TDOA error reasons to the location server. See the Abstract Syntax Notation One (ASN.1) example of Appendix Item 21.

In response to receiving these error measures and notifications from a first UE, the Network/LMF may transmit to one or more UEs, with mitigation information. This may include notification to one or more UEs of the nearby error cases that may have potential impacts, to assist the UEs in positioning measurements, and calculations. This information could be sent in LPP provide assistance data messages (P2P or Broadcast posSIBs) by removing TRPs/beams associated with PRS resource IDs from the configuration(s).

Solutions for Problem 4

The NR SDT feature can be based on the similar concepts as mobile originated EDT in LTE [11, 12]. Similar to LTE, two different type of UL data transfer can be supported on Common Control Channel (CCCH):

The UL small data is contained in a NAS message octet string in a separate UL RRC message. The UL RRC message is used for SDT procedures only. The contained small data is forwarded from the receiving radio access network node to AMF in core network

The UL small data is transmitted on DTCH multiplexed with UL RRC Resume Request message and forwarded from receiving radio access network node to AMF in core network

If the small data contains positioning related data, there are three possible embodiments for the UL message to convey small data:

The UL message carries an indicator that can be used to identify the type of small data in the NAS message from two possible types: 1) user plane data or user plane related positioning data 2) control plane related positioning data

The contained NAS message carries an indicator that can be used to identify the type of small data in the NAS message from two possible types: 1) user plane data or user plane related positioning data or 2) control plane related positioning data

The UL message has separate and independent octet strings for NAS messages to contain 1) user plane data or user plane related positioning data and 2) control plane related positioning data, where both octet strings can be contained in the message at the same time

The UL message can be a separate RRC message specifically designed for small data transfer, but the indicator can also be included either in a Medium Access Control (MAC) header or in RRC Resume Request message in case the small data is transferred multiplexed on the DTCH together with RRC Resume Request message. It should be noted in case the indicator is included in the MAC header, the indicator may be specified in the form of a logical channel that is specific to small data transfer, or a logical channel specific to small data transfer may be use as an SDT indicator.

The solution is composed of following steps in different nodes:

An SDT capable radio access network node includes a SDT indicator to a transmitted system information message to indicate that SDT procedure is allowed in its cells. The transferred system information message can be NR master information block, an extension to an existing system information block type or a new system information block type. The indicator does not need to be broadcasted in all cells that belongs to the same radio access network node, but only in such cells where SDT is allowed. The indicator can be implemented as a presence bit where presence indicates that SDT procedures are allowed, and absence indicates that SDT procedure is prohibited.

Upon arrival of small data in RRC_INACTIVE state in the UE's transmitter buffer, the UE initiates SDT procedure only if the SDT indicator is present in the system information of the current cell. Otherwise, the UE considers that SDT procedure is prohibited. This is to ensure interoperability with legacy network equipment where the indicator is not implemented and therefore cannot be set to be either present of absent.

Cell re-selection criteria may be fulfilled while small data transfer is underway. Prior to cell re-selection, the UE reads the SDT indicator from the system information of the new cell. The UE may use the value of the indicator to make one or more of the following decisions:

Select or prioritize an SDT capable cell over a non-SDT capable cell for cell re-selection. If the UE re-selects to a cell where SDT procedures are allowed, the UE may resume the SDT procedure in the new cell. In that case, the UE can send a RRC Resume requests message accompanied with small data to the new cell and continue with SDT procedure.

If the UE re-selects to a cell where SDT procedures are not allowed, for example if the UE does not find any SDT capable cells as re-selection candidate cells, the UE may complete initiated SDT procedure in the source cell before executing cell re-selection.

Interrupt the ongoing SDT procedure, request a transition to RRC_CONNECTED state, and continue data transmission in RRC_CONNECTED state. This may be the case, if the UE finds no SDT capable candidate cell for cell re-selection. The UE may include mobility measurement into the RRC Resume request to assist the triggering of handover procedure by its serving node. If RRC Connection request is rejected or failed, the UE transitions to RRC_IDLE state, performs cell reselection and starts over the transmission of small data following normal data transfer procedure from scratch in the new cell.

Transition to RRC IDLE, perform cell reselection and starts over the transmission of small data following normal data transfer procedure from scratch in the new cell.

If SDT procedure is triggered and the SDT data conveys positioning data, there are four possible solutions:

The UE adds an indicator bit to the NAS message that conveys information about the type of small data. The indicator is read by AMF to determine where to forward the small data.

The UE adds an indicator bit to a RRC message or MAC header to convey information about the type of small data. The receiving radio access network nodes adds the indicator from the received RRC message to the NG interface frame that transfers the small data to AMF

The UE populates separate NAS messages for 1) user plane data or user plane related positioning data and 2) control plane related positioning data.

The UE populates separate NAS messages for 1) user plane data, 2) user plane related positioning data and 3) control plane related positioning data.

Upon reception of small data in AMF, if indicators are used, the AMF will read the indicator either from the small data itself or from the NG frame to determine whether the data is positioning related or not. If the indicator value indicates presence of control plane related positioning data, the small data is forwarded to LMF.

If separate NAS messages are used for 1) user plane data or user plane related positioning data and 2) control plane related positioning data, the AMF will forward control plane related positioning data to LMF and the user plane data to UPF.

If separate NAS messages are used for 1) user plane data, 2) user plane related positioning data and 3) control plane related positioning data, the AMF will forward control plane related positioning data to LMF and the user plane data to UPF.

Example Environments

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G.” 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHZ, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

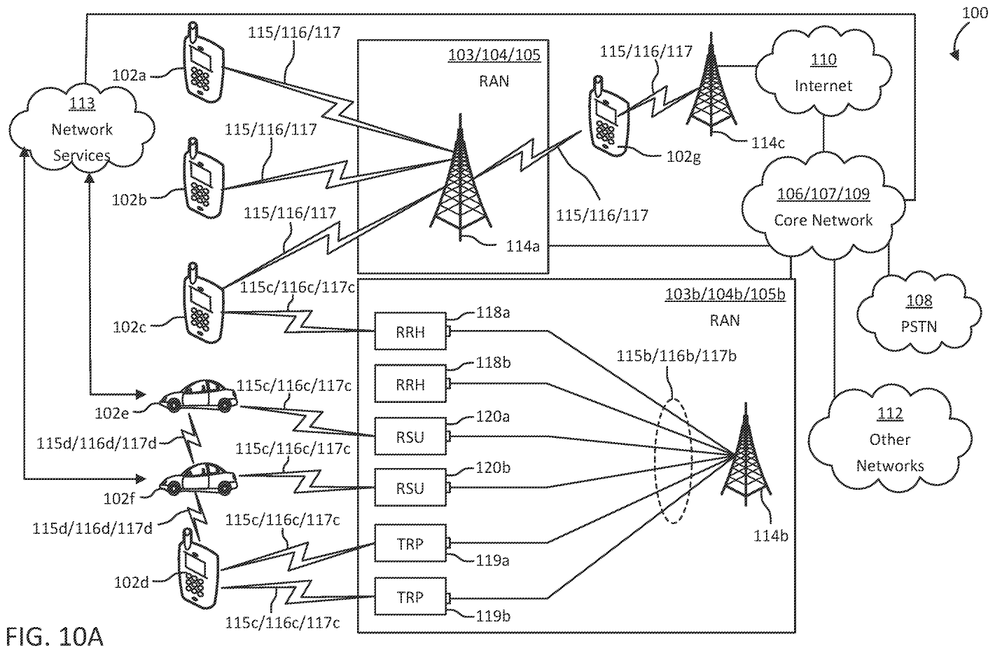

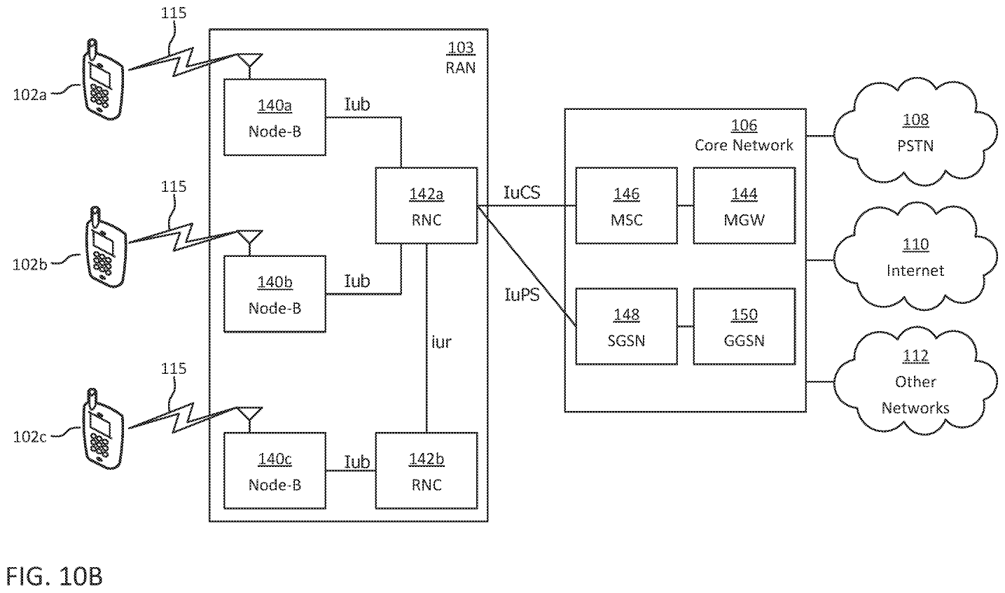

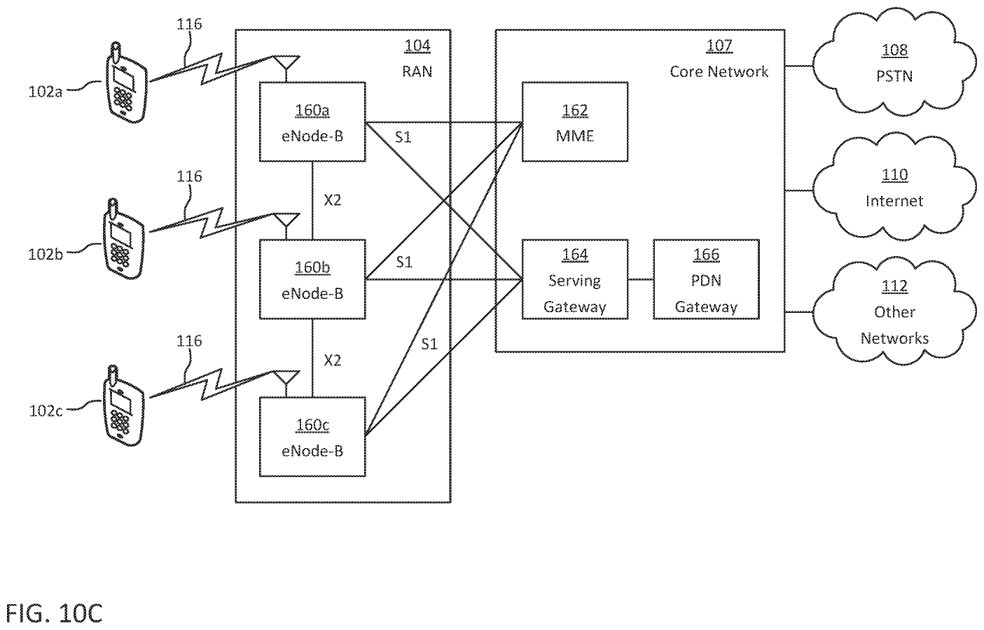

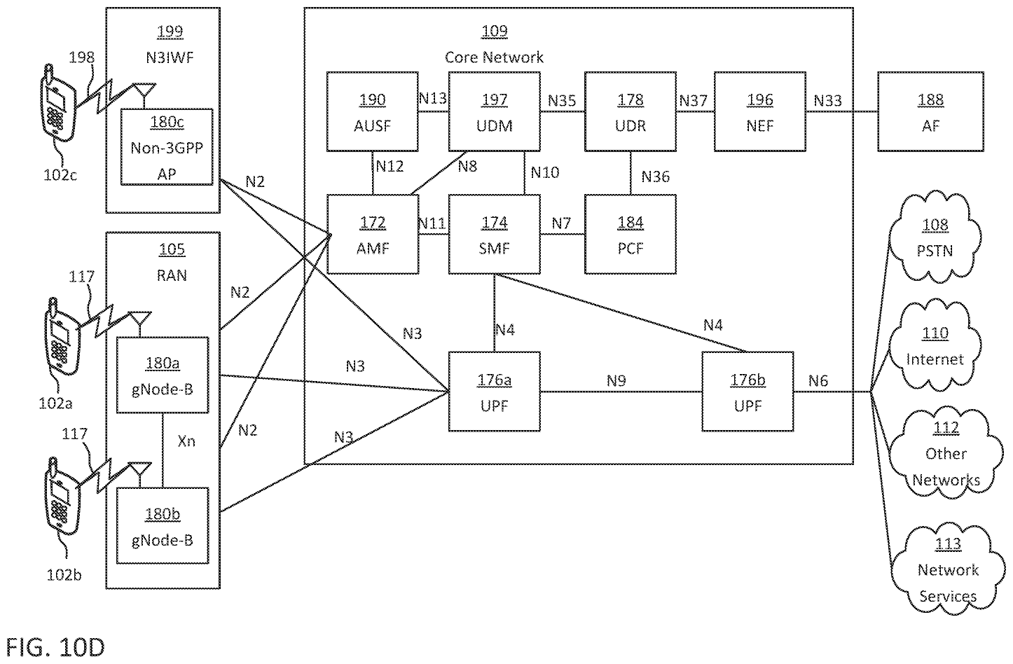

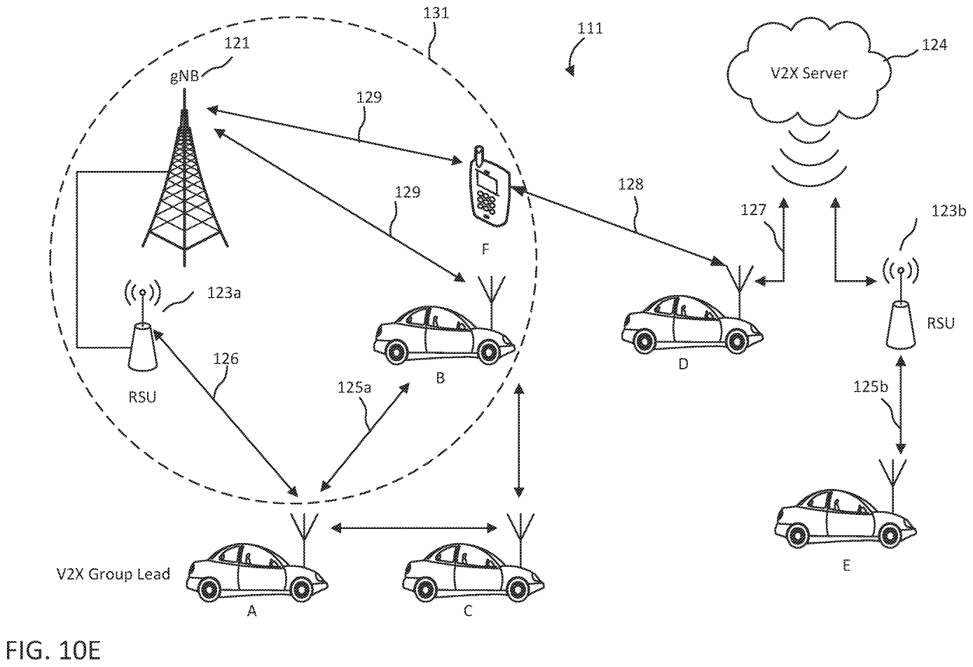

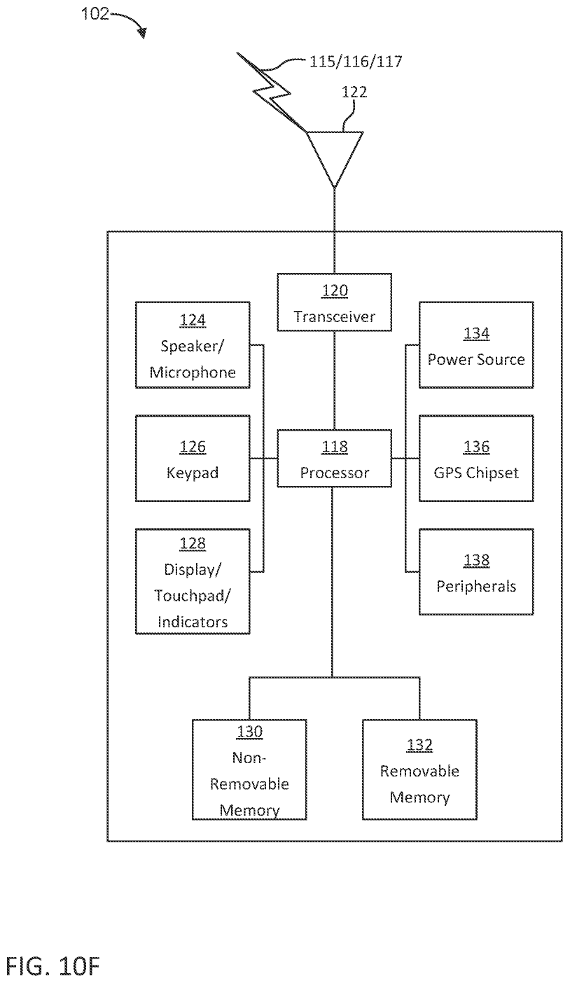

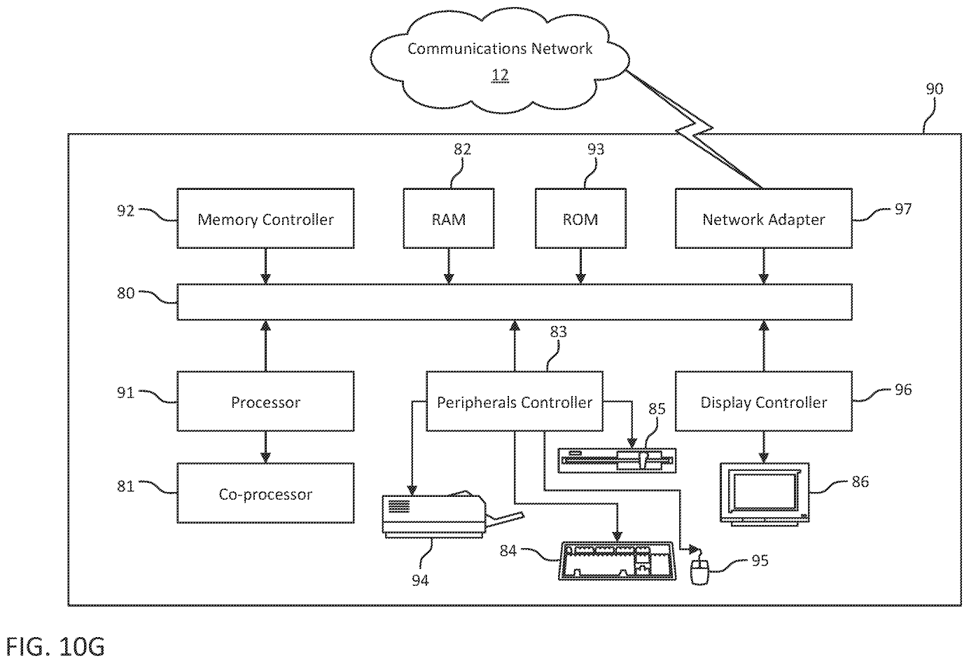

FIG. 10A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 10A, each of the WTRUs 102 is depicted in FIGS. 10A-E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 10A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 10A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 10A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 10A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 10A may be configured to communicate with the base station 114a, which may employ a cellular-based radio technology, and with the base station 114c, which may employ an IEEE 802 radio technology.

Although not shown in FIG. 10A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 10B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 10B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 10B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 10B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 10C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 10C, the eNode-Bs 160a, 160b, and 160c may communicate with one another over an X2 interface.

The core network 107 shown in FIG. 10C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 10D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 10D, the gNode-Bs 180a and 180b may communicate with one another over an Xn interface, for example.

The core network 109 shown in FIG. 10D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 10G.

In the example of FIG. 10D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 10D shows that network functions directly connect to one another, however, it should be appreciated that they may communicate via routing agents such as a diameter routing agent or message buses.

In the example of FIG. 10D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 10D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 10D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 10D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, which serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIG. 10A, FIG. 10C, FIG. 10D, and FIG. 10E are identified by the names given to those entities in certain existing 3GPP specifications, but it is understood that in the future those entities and functionalities may be identified by other names and certain entities, or functions may be combined in future specifications published by 3GPP, including future 3GPP NR specifications. Thus, the particular network entities and functionalities described and illustrated in FIGS. 10A-E are provided by way of example only, and it is understood that the subject matter disclosed and claimed herein may be embodied or implemented in any similar communication system, whether presently defined or defined in the future.

FIG. 10E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Roadside Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUS A, B, C, D, E, and F may communicate with each other over a Uu interface 129 via the gNB 121 if they are within the access network coverage 131. In the example of FIG. 10E, WTRUs B and F are shown within access network coverage 131. WTRUS A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 10E, WRTU D, which is outside of the access network coverage 131, communicates with WTRU F, which is inside the coverage 131.

WTRUS A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 10F is a block diagram of an example apparatus or device WTRU 102 that may be configured for wireless communications and operations in accordance with the systems, methods, and apparatuses described herein, such as a WTRU 102 of FIGS. 10A-E. As shown in FIG. 10F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 10F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 10F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 10A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 10F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 10G is a block diagram of an exemplary computing system 90 in which one or more apparatuses of the communications networks illustrated in FIG. 10A, FIG. 10C, FIG. 10D and FIG. 10E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 10A-10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

APPENDIX ITEM 1
-- ASN1START
NR-DL-PRS-Info-r16 ::= SEQUENCE {

| | |
|---|---|
| nr-DL-PRS-ResourceSetList-r16 | SEQUENCE (SIZE (1..nrMaxSetsPerTrp-r16)) OF |
| | NR-DL-PRS-ResourceSet-r16, |

...
}
NR-DL-PRS-ResourceSet-r16 ::= SEQUENCE {

| | |
|---|---|
| nr-DL-PRS-ResourceSetID-r16 | NR-DL-PRS-ResourceSetID-r16, |

```
  dl-PRS-Periodicity-and-ResourceSetSlotOffset-r16
      NR-DL-PRS-Periodicity-and-ResourceSetSlotOffset-r16,
```

| dl-PRS-ResourceRepetitionFactor-r16 | ENUMERATED {n2, n4, n6, n8, n16, n32, ...} | |
|---|---|---|
| | OPTIONAL, | -- Need OP |
| dl-PRS-ResourceTimeGap-r16 | ENUMERATED {s1, s2, s4, s8, s16, s32, ...} | |
| | OPTIONAL, | -- Cond Rep |
| dl-PRS-NumSymbols-r16 | ENUMERATED {n2, n4, n6, n12, ...}, | |
| dl-PRS-MutingOption1-r16 | DL-PRS-MutingOption1-r16 | OPTIONAL, -- Need OP |
| dl-PRS-MutingOption2-r16 | DL-PRS-MutingOption2-r16 | OPTIONAL, -- Need OP |

| | |
|---|---|
| dl-PRS-ResourcePower-r16 | INTEGER (−60..50), |
| dl-PRS-ResourceList-r16 | SEQUENCE (SIZE (1..nrMaxResourcesPerSet-r16)) OF |
| | NR-DL-PRS-Resource-r16, |

```
  ...
}
DL-PRS-MutingOption1-r16 ::= SEQUENCE {
  dl-prs-MutingBitRepetitionFactor-r16
```

| | |
|---|---|
| ENUMERATED { n1, n2, n4, n8, ... } | OPTIONAL, -- Need OP |

| | |
|---|---|
| nr-option1-muting-r16 | NR-MutingPattern-r16, |

...
}
DL-PRS-MutingOption2-r16 ::= SEQUENCE {

| | |
|---|---|
| nr-option2-muting-r16 | NR-MutingPattern-r16, |

...
}
NR-MuttingPattern-r16 ::= CHOICE {

| | |
|---|---|
| po2-r16 | BIT STRING (SIZE(2)), |
| po4-r16 | BIT STRING (SIZE(4)), |
| po6-r16 | BIT STRING (SIZE(6)), |
| po8-r16 | BIT STRING (SIZE(8)), |
| po16-r16 | BIT STRING (SIZE(16)), |
| po32-r16 | BIT STRING (SIZE(32)), |

...
}
NR-DL-PRS-Resource-r16 ::= SEQUENCE {

| | |
|---|---|
| nr-DL-PRS-ResourceID-r16 | NR-DL-PRS-ResourceID-r16, |
| dl-PRS-SequenceID-r16 | INTEGER (0.. 4095), |
| dl-PRS-CombSizeN-AndReOffset-r16 | CHOICE { |
| n2-r16 | INTEGER (0..1), |
| n4-r16 | INTEGER (0..3), |
| n6-r16 | INTEGER (0..5), |
| n12-r16 | INTEGER (0..11), |

```
    ...
  },
```

| dl-PRS-ResourceSlotOffset-r16 | INTEGER (0..nrMaxResourceOffsetValue-1-r16), | |
|---|---|---|
| dl-PRS-ResourceSymbolOffset-r16 | INTEGER (0..12), | |
| dl-PRS-QCL-Info-r16 | DL-PRS-QCL-Info-r16 | OPTIONAL, |

...

APPENDIX ITEM 2
NR-DL-PRS-Info field descriptions

dl-PRS-Periodicity-and-ResourceSetSlotOffset
This field specifies the periodicity of DL-PRS allocation in slots configured per DL-PRS Resource Set and the slot offset with respect to SFN #0
slot #0 for a TRP where the DL-PRS Resource Set is configured (i.e. slot where the first DL-PRS Resource of DL-PRS Resource Set occurs).
dl-PRS-ResourceRepetitionFactor
This field specifies how many times each DL-PRS Resource is repeated for a single instance of the DL-PRS Resource Set. It is applied to all
resources of the DL-PRS Resource Set. Enumerated values n2, n4, n6, n8, n16, n32 correspond to 2, 4, 6, 8, 16, 32 resource repetitions,
respectively. If this field is absent, the value for dl-PRS-ResourceRepetitionFactor is 1 (i.e., no resource repetition).
dl-PRS-ResourceTimeGap
This field specifies the offset in units of slots between two repeated instances of a DL-PRS Resource corresponding to the same DL-PRS
Resource ID within a single instance of the DL-PRS Resource Set. The time duration spanned by one DL-PRS Resource Set containing repeated
DL-PRS Resources should not exceed DL-PRS-Periodicity.
dl-PRS-NumSymbols
This field specifies the number of symbols per DL-PRS Resource within a slot.
dl-PRS-MutingOption1
This field specifies the DL-PRS muting configuration of the TRP for the Option-1 muting, as specified in TS 38.214 [45], and
comprises the following sub-fields:

| | |
|---|---|
| - | dl-prs-MutingBitRepetitionFactor indicates the number of consecutive instances of the DL-PRS Resource Set |
| | corresponding to a single bit of the nr-option1-muting bit map. Enumerated values n1, n2, n4, n8 correspond to 1, 2, 4, 8 |
| | consecutive instances, respectively. If this sub-field is absent, the value for dl-prs-MutingBitRepetitionFactor is n1. |
| - | nr-option1-muting defines a bitmap of the time locations where the DL-PRS Resource is transmitted (value ‘1’) or not |
| | (value ‘0’) for a DL-PRS Resource Set, as specified in TS 38.214 [45]. |

If this field is absent, Option-1 muting is not in use for the TRP.
dl-PRS-MutingOption2
This field specifies the DL-PRS muting configuration of the TRP for the Option-2 muting, as specified in TS 38.214 [45], and comprises the
following sub-fields:

| | |
|---|---|
| - | nr-option2-muting defines a bitmap of the time locations where the DL-PRS Resource is transmitted (value ‘1’) or not (value ‘0’). Each |
| | bit of the bitmap corresponds to a single repetition of the DL-PRS Resource within an instance of a DL-PRS Resource Set, as specified in |
| | TS 38.214 [45]. The size of this bitmap should be the same as the value for dl-PRS-ResourceRepetitionFactor. |

If this field is absent, Option-2 muting is not in use for the TRP.
dl-PRS-ResourcePower
This field specifies the average EPRE of the resources elements that carry the PRS in dBm that is used for PRS transmission. The UE assumes
constant EPRE is used for all REs of a given DL-PRS resource.
dl-PRS-SequenceID
This field specifies the sequence Id used to initialize cᵢₙᵢₜ value used in pseudo random generator TS 38.211 [41], clause 5.2.1 for generation of
DL-PRS sequence for transmission on a given DL-PRS Resource.
dl-PRS-CombSizeN-AndReOffset
This field specifies the Resource Element spacing in each symbol of the DL-PRS Resource and the Resource Element (RE) offset in the
frequency domain for the first symbol in a DL-PRS Resource. All DL-PRS Resource Sets belonging to the same Positioning Frequency Layer
have the same value of comb size. The relative RE offsets of following symbols are defined relative to the RE Offset in the frequency domain
of the first symbol in the DL-PRS Resource according to TS 38.211 [41]. The comb size configuration should be aligned with the comb size
configuration for the frequency layer.
dl-PRS-ResourceSlotOffset
This field specifies the starting slot of the DL-PRS Resource with respect to the corresponding DL-PRS-Resource Set Slot Offset.
dl-PRS-ResourceSymbolOffset
This field specifies the starting symbol of the DL-PRS Resource within a slot determined by dl-PRS-ResourceSlotOffset.
dl-PRS-QCL-Info
This field specifies the QCL indication with other DL reference signals for serving and neighboring cells and comprises the following subfields:

| - | ssb indicates the SSB information for QCL source and comprises the following sub-fields: | |
|---|---|---|
| | - | pci specifies the physical cell ID of the cell with the SSB that is configured as the source reference signal for the DL-PRS. The UE |
| | | obtains the SSB configuration for the SSB configured as source reference signal for the DL-PRS by indexing to the field nr-SSB-Config |
| | | with this physical cell identity. |
| | - | ssb-Index indicates the index for the SSB configured as the source reference signal for the DL-PRS. |
| | - | rs-Type indicates the QCL type. |
| - | dl-PRS indicates the PRS information for QCL source and comprises the followings sub-fields: | |
| | - | qcl-DL-PRS-ResourceID specifies DL-PRS Resource ID as the source reference signal for the DL-PRS. |
| | - | qcl-DL-PRS-ResourceSetID specifies the DL-PRS Resource Set ID. |

APPENDIX ITEM 3

| | |
|---|---|
| posSibType6-1 | NR-DL-PRS-AssistanceData |
| posSibType6-2 | NR-UEB-TRP-LocationData |
| posSibType6-3 | NR-UEB-TRP-RTD-Info |

APPENDIX ITEM 4

| 1. | Method and system for a UE to perform positioning measurements and associated location determination for discontinuous DL | |
|---|---|---|
| | positioning reference signals that are received from TRPs/gNBs, comprising one or more of: | |
| | a. | The UE receiving from the network, a first PRS reception resource and configuration set |
| | b. | The UE receiving from the network one or more triggers for measurement and evaluation of the first PRS reception |

| resources and configuration set, which includes one or more of the following: | |
|---|---|
| i. | One or more events (e.g., location service request, cell (re)selection, periodic measurement(s), detection of a |
| | positioning signal, emergency call, (de)activation of a set or subset of PRS reception resources, etc.) |
| ii. | A Request Config Allowed parameter set for reconfiguration of UE PRS, or to enable or disable measurement and |
| | evaluation of received UE PRS, the Request Config Allowed parameter set consisting of one or more of the |
| | following aspects |
| | 1. Specific to UE |
| | 2. Associated with a serving cell/beam/area |
| | 3. Associated with (de)activation of a preconfigured PRS resource set or subset |
| | 4. Counter limit (e.g., number of UE requests allowed) |
| | 5. Validity/Time limit, and/or associated prohibit timer |
| | 6. Service type |
| | 7. Emergency services |
| | 8. Other service type/level |
| | 9. QoS attributes including latency requirement. |
| iii. | Validity for the measurement and evaluation trigger consisting of one or more of the following: |

```
    1. Associated with a particular RAT
    2. Associated with (de)activation of a preconfigured PRS resource set or subset
    3. an associated granularity (gNB/TRP, beam, TA, RNA, PLMN, S-NSSAI, etc.)
    4. validity time
    5. validity timer
    6. prohibit timer to limit number of successive measurement and evaluation triggers
```

| | |
|---|---|
| c. | The UE performing measurement and evaluation of a first PRS resource and configuration versus a positioning quality |

| parameter set for KPIs including one or more of the following: | |
|---|---|
| i. | QoS, positioning accuracy, positioning latency, inter-cell interference, measurements and associated thresholds |

or levels consisting of criteria to trigger a PRS transmission reconfiguration request(s)

| | |
|---|---|
| d. | The UE determining that the criteria for a PRS transmission/resource request has been met, and as a result, the UE |

| generates and transmits a PRS transmission request, including one or more of the following: | |
|---|---|
| i. | coarse location, |
| ii. | UE capabilities and current configuration, |
| iii. | PRS measurement set, PRS transmission configuration parameters and/or PRS resource identifiers, |
| iv. | other positioning measurements such as LOS/NLOS, SSB, multipath detection, cell-edge, and mobility measures. |

| | |
|---|---|
| e. | The UE (and optionally nearby UEs in serving/neighbor cells ) receiving from the serving network, notification for |

| reconfigurations, wherein the notification includes one or more of: | |
|---|---|
| i. | Notification of grant, partial grant, (de)activation, or denial/unavailable PRS (re)configuration by extending one |
| | or more of the following messages and procedures: |
| a) | LPP ProvideLocationInformation |
| b) | New configuration set(s)/group, validity period for the new configuration |
| c) | LPP RequestLocationInfrmation |
| d) | Prioritization of measurements for newly configured TRPs |
| e) | Broadcast SI notification and update of associated posSIB(s) |
| f) | In case of denial of PRS transmission request, receiving notification for fallback behavior, e.g., new positioning |
| | method. |
| g) | One or more RRC messages |
| h) | MAC-CE or DCI to activate a set or subset of PRS resources |
| i) | MAC-CE to indicate activation of PRS resources and use DCI to dynamically indicate the set/subset of PRS |
| | resources to use for measurements and/or measurement reporting |
| ii. | A second PRS reception resource and configuration set, including the following: Off/On transmission, more/less |

resources, muting pattern, emergency configuration, measurement configurations.

| | |
|---|---|
| f. | UE processing the (re)configuration and may perform positioning measurements, positioning measurement evaluation, |

or positioning calculation based on the second received PRS resource and configuration set

APPENDIX ITEM 5

| 2. | Method and system for a location server (e.g., LMF) operatively coupled with one or more TRPs or base stations and UEs, to | |
|---|---|---|
| | modify discontinuous DL positioning reference signals transmitted from TRPs/gNBs, methods comprising: | |
| | a. | The location server initially transmitting a first PRS transmission configuration (including PRS disabled) to TRPs and UEs |

| i. | including a validity information, wherein the validity information includes one or more of an associated |
|---|---|
| | granularity (gNB/TRP, beam, TA, RNA, PLMN, S-NSSAI, etc.), a validity time, a validity RAT; and |
| ii. | reconfigRequestAllowed parameter set, wherein the reconfigRequestAllowed parameter set may be |

characterized by one or more of the following aspects: Specific to UE, Associated with a serving cell/beam/area,
Counter limit (e.g., number of UE requests allowed), Validity/Time limit, Service type, Emergency services, Other
service type/level, QoS attributes including latency requirement .

| b. | Optionally, the location server transmitting, a request, including one or more of the following: required class/level of |
|---|---|
| | service, service type, QoS attributes, UE capabilities, measurements/position estimate, current PRS resource |
| | configuration(s). This process may also require some acknowledgement from the TRP/gNB. |
| c. | The location server evaluating positioning resource set(s), current PRS configuration(s) and/or UE characteristics, |

| including, but not limited to | |
|---|---|
| i. | UE(s) measurements, |
| ii. | gNB measurements, e.g., SRS transmitted by UE(s), |
| iii. | (re)configuration requests, |
| iv. | Number of LCS requests over time |
| v. | UE(s) capabilities, |
| vi. | service types sets, and |
| vii. | minimum KPI (e.g., QoS) sets from one or more UEs/TRPs. |

| | |
|---|---|
| d. | The location server evaluating whether criteria has been met for triggering of positioning and PRS (re)configuration. |
| e. | The location server determining that the triggering criteria has been met, the location server requesting TRP(s) PRS |

| transmissions/resources to be modified including | |
|---|---|
| i. | to a new configuration set |
| ii. | pre-determined duration. |

| f. | The location server determining that the triggering criteria has not been met, the location server continuing to re- |
|---|---|
| | evaluate the criteria for triggering (re)configuration. |
| g. | The location server transmitting to UE(s) via broadcast posSIBs, via P2P, a combination therefore or other means, |

positioning and measurements configuration updates for a second PRS transmission resource and configuration set.

APPENDIX ITEM 6

| 3. | Method to reduce latency associated with discontinuous PRS reception and UE requests for modifications to received PRS | |
|---|---|---|
| | transmissions comprising of | |
| | a. | UE requests other SI (on-demand posSIBs) by reading SIB1 and scheduling information for posSIB(s) associated with PRS |
| | | transmissions. |
| | b. | UE request of On-demand posSIBs, which is also acts as a trigger for the network (gNB, LMF) to activate or modify one |
| | | or more TRP PRS transmissions and/or reconfigure existing transmissions. |
| | c. | For UE request for posSIBs in RRC_IDLE and RRC_INACTIVE triggers the following: |

| | |
|---|---|
| i. | Random Access (RACH) procedure. |
| ii. | Reading SI scheduling information from SIB1. |
| iii. | UE determines broadcast status (via si-BroadcastStatus) of a posSIB associated with PRS transmissions. This field |

| indicates if one or more posSIBs within the SI-message are being broadcast or not. | |
|---|---|
| 1. | If si-BroadcastStatus is set to ‘broadcasting’, the UE would acquire the concerned posSIB(s) “normally”. |
| | This could serve as an implicit indication that PRS transmission reconfiguration requests are not possible. |
| 2. | If si-BroadcastStatus is set to ‘notbroadcasting’, the UE proceeds with RACH procedure to acquire |
| | posSIB(s) associated with PRS transmissions for the serving cell. For this procedure, if the network |
| | configures the UE with resources for the posSIB request, this can also be an implicit trigger for the |
| | network (e.g., gNB/TRP or LMF) to activate or modify one or more TRP PRS transmissions with the |
| | serving cell and neighbor cells. |
| 3. | Nearby UEs that perform cell (re)selection receive the new posSIB, an associated validity for the posSIB, |

and PRS reconfigurations, reducing latency for receiving PRS transmission reconfigurations.

| d. | For nearby UEs in RRC_CONNECTED, the network can provide posSIB updates through dedicated signaling using the |
|---|---|
| | RRCReconfiguration message in the case that PRS transmission (re)configuration has occurred and/or via paging |
| | message over short message. |
| e. | One or more UE receive notification of PRS resource configuration updates as part of a paging notification, further |

| comprising | |
|---|---|
| i. | request to the UE to calculate and/or report its position, or |
| ii. | request to the UE to report positioning related measurements |

| 4. | Methods and system to reduce latency associated with discontinuous PRS transmissions as described above, comprised of one | |
|---|---|---|
| | or more of the following: | |
| | a. | For UE with reconfigRequestAllowed parameter set including measurements of a first PRS configuration, configure |
| | | measurement reports allowing subsequent UE-assisted measurement reports to be concatenated by the network for |
| | | positioning determination. |
| | b. | UE receiving, as part of a second PRS transmission resource and configuration set |

| | |
|---|---|
| i. | reception and measurement prioritization for newly configured TRPs |
| ii. | configuration associated with reporting additional PRS measurements based on the reconfiguration in |

RRC_IDLE/INACTIVE via methods such as Small Data Transmission (SDT), MAC-CE, or CG-based transmission.

| | |
|---|---|
| c. | UE and/or gNB configured with a plurality of PRS transmission configurations comprising |

| | |
|---|---|
| i. | Grouping multiple sets of parameters into configuration sets/levels at UE or gNB |
| ii. | Validity associated with each group of configurations |
| iii. | Semi-persistent or persistent PRS transmission configuration(s) stored and quickly accessed/activated. |
| iv. | For certain device types, e.g. REDCAP, non-mobile UEs. |

APPENDIX ITEM 7

| 5. | Methods and system for a first device to identify and mitigate error sources related to discontinuous PRS reception as | |
|---|---|---|
| | described above, comprised of one or more of the following: | |
| | a. | UE, receiving from the network, a PRS measurement and associated positioning calculation error source reporting |

| configuration, comprising | |
|---|---|
| i. | Threshold(s) of acceptable and/or unacceptable levels of interference |
| ii. | Threshold(s) for delay spreads as a result of multipath associated with the PRS signals |
| iii. | Threshold(s) for the number of TRPs without LoS or identification of NLOS/LoS. |
| iv. | An associated prohibit timer related to the error source reporting and avoid excessive number of reports |

| | |
|---|---|
| b. | UE transmitting to the network in PRS measurement report(s) and/or UE PRS reconfiguration requests, one or more of |

| the following detected error sources and quantitative measures | |
|---|---|
| i. | Multi-path and LOS/NLOS Identification for serving and neighbor cells |
| ii. | Insufficient number of TRPs/gNBs for PRS-related positioning calculations, e.g., RTT, TDOA, AoD |
| iii. | PRS intercell interference as increased PRS transmit power improves hear-ability and accuracy, but may increase |

possibility of interference with neighbor cells

| | |
|---|---|
| c. | Network upon reception of PRS measurement report(s) and/or UE PRS reconfiguration requests inclusive of potential |

| error sources, initiates one or more of the following | |
|---|---|
| i. | Re-allocation of PRS resources and update PRS configurations considering potential for interference |
| ii. | Activate/update muting patterns for serving and/or neighbor cells |
| iii. | Used as an input to determine/calculate confidence and uncertainty of position/measurements |
| iv. | Trigger for UE-initiated PRS request allowed and evaluation and/or |
| v. | Configure UE to use other fallback positioning methods or |
| vi. | Require validation of measurements and position determination with other positioning technologies/methods |
| vii. | For the above actions, LMF reconfigure a plurality of UEs within an area or vicinity via P2P or broadcast signaling |

APPENDIX ITEM 8
Values of LCID for DL-SCH

| Codepoint/ | |
|---|---|
| Index | LCID values |
| 0 | CCCH |
| 1-32 | Identity of the logical channel |
| 33 | Extended logical channel ID field (two-octet eLCID field) |
| 34 | Extended logical channel ID field (one-octet eLCID field) |
| 35-45 | Reserved |
| 46 | PRS resource subset activation/deactivation |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific PDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

APPENDIX ITEM 9
-- ASN1START
NR-DL-PRS-AssistanceData-r16 ::= SEQUENCE {

| | |
|---|---|
| nr-DL-PRS-ReferenceInfo-r16 | DL-PRS-ID-Info-r16, |

nr-DL-PRS-AssistanceDataList-r16 SEQUENCE (SIZE (1..nrMaxFreqLayers-r16)) OF

| | NR-DL-PRS-AssistanceDataPerFreq-r16, | |
|---|---|---|
| nr-SSB-Config-r16 | SEQUENCE (SIZE (1..nrMaxTRPs-r16)) OF | |
| | NR-SSB-Config-r16 | OPTIONAL, -- Need ON |

```
  ...
}
NR-DL-PRS-AssistanceDataPerFreq-r16 ::= SEQUENCE {
  nr-DL-PRS-PositioningFrequencyLayer-r16
```

NR-DL-PRS-PositioningFrequencyLayer-r16,

nr-DL-PRS-AssistanceDataPerFreq-r16 SEQUENCE (SIZE (1..nrMaxTRPsPerFreq-r16)) OF

NR-DL-PRS-AssistanceDataPerTRP-r16,

...
}
NR-DL-PRS-AssistanceDataPerTRP-r16 ::= SEQUENCE {

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- Need ON |
| nr-ARFCN-r16 | ARFCN-ValueNR-r15 | OPTIONAL, -- Need ON |

| | |
|---|---|
| nr-DL-PRS-SFN0-Offset-r16 | NR-DL-PRS-SFN0-Offset-r16, |
| nr-DL-PRS-ExpectedRSTD-r16 | INTEGER (−3841..3841), |

nr-DL-PRS-ExpectedRSTD-Uncertainty-r16

| | |
|---|---|
| | INTEGER (0..246), |
| nr-DL-PRS-Info-r16 | NR-DL-PRS-Info-r16, |

...,

| | |
|---|---|
| nr-DL-PRS-ConfigRqst-r17 | NR-DL-PRS-ConfigRqst-r17 |

}
NR-DL-PRS-ConfigRqst-r17 ::= SEQUENCE {

| | | |
|---|---|---|
| dl-PRS-ConfigRqstAllowed | BOOLEAN | OPTIONAL, |
| dl-PRS-measPriorityOrPrioritySet | INTEGER (0..255) | OPTIONAL, |
| dl-PRS-ValidityTime | INTEGER (0..2176) | OPTIONAL, -- Alternatively UTC |

start/stop time

| | | |
|---|---|---|
| dl-PRS-prohibitTimer | INTEGER (0..2176) | OPTIONAL |
| dl-PRS-KPI-required | DL-PRS-KPI-required | OPTIONAL, |
| dl-PRS-servicetype | INTEGER (0..15) | OPTIONAL, |

...
}
DL-PRS-KPI-required-r17 ::= SEQUENCE {

| | | |
|---|---|---|
| dl-PRS-accuracy | DL-PRS-accuracy | OPTIONAL, -- threshold |
| dl-PRS-latency | DL-PRS-latency | OPTIONAL, -- threshold |
| dl-PRS-IC-interference | DL-PRS-IC-interference | OPTIONAL, -- threshold |

```
  ...
}
NR-DL-PRS-PositioningFrequencyLayer-r16 ::= SEQUENCE {
  dl-PRS-SubcarrierSpacing-r16 ENUMERATED {kHz15, kHz30, kHz60, kHz120, ...},
```

| | |
|---|---|
| dl-PRS-ResourceBandwidth-r16 | INTEGER (1..63), |
| dl-PRS-StartPRB-r16 | INTEGER (0..2176), |
| dl-PRS-PointA-r16 | ARFCN-ValueNR-r15, |
| dl-PRS-CombSizeN-r16 | ENUMERATED {n2, n4, n6, n12, ...}, |
| dl-PRS-CyclicPrefix-r16 | ENUMERATED {normal, extended, ...}, |

...
}
NR-DL-PRS-SFN0-Offset-r16 ::= SEQUENCE {

| | |
|---|---|
| sfn-Offset-r16 | INTEGER (0..1023), |
| integerSubframeOffset-r16 | INTEGER (0..9), |

...}
-- ASN1STOP

APPENDIX ITEM 10
NR-DL-PRS-AssistanceData field descriptions

nr-DL-PRS-ReferenceInfo
This field specifies the IDs of the assistance data reference TRP.
nr-DL-PRS-AssistanceDataList
This field specifies the DL-PRS resources for each frequency layer.
nr-SSB-Config
This field specifies the SSB configuration of the TRPs.
nr-DL-PRS-PositioningFrequencyLayer
This field specifies the Positioning Frequency Layer for the nr-DL-PRS-AssistanceDataPerFreq field.
nr-DL-PRS-AssistanceDataPerFreq
This field specifies the DL-PRS Resources for the TRPs within the Positioning Frequency Layer.
dl-PRS-ID
This field is used along with a DL-PRS Resource Set ID and a DL-PRS Resource ID to uniquely identify a DL-PRS Resource, and is
associated with a single TRP.
nr-PhysCellID
This field specifies the physical cell identity of the TRP.
nr-CellGlobalID
This field specifies the NCGI, the globally unique identity of a cell in NR, as defined in TS 38.331 [35].
nr-ARFCN
This field specifies the NR-ARFCN of the TRP.
nr-DL-PRS-SFN0-Offset
This field specifies the time offset of the SFN#0 slot#0 for the given TRP with respect to SFN#0 slot#0 of the assistance data
reference TRP and comprises the following subfields:

| | |
|---|---|
| - | sfn-Offset specifies the SFN offset at the TRP antenna location between the assistance data reference TRP and this |
| | neighbour TRP. |
| | The offset corresponds to the number of full radio frames counted from the beginning of a radio frame #0 of the assistance |
| | data reference TRP to the beginning of the closest subsequent radio frame #0 of this neighbour TRP. |
| - | integerSubframeOffset specifies the frame boundary offset at the TRP antenna location between the assistance data |
| | reference TRP and this neighbour TRP counted in full subframes. |
| | The offset is counted from the beginning of a subframe #0 of the assistance data reference TRP to the beginning of the |
| | closest subsequent subframe #0 of this neighbour TRP, rounded down to multiples of subframes. |

nr-DL-PRS-ExpectedRSTD
This field indicates the RSTD value that the target device is expected to measure between this TRP and the assistance data
reference TRP. The nr-DL-PRS-ExpectedRSTD field takes into account the expected propagation time difference as well as
transmit time difference of PRS positioning occasions between the two TRPs. The resolution is 4×Tₛ, with Tₛ=1/(15000*2048)
seconds.
nr-DL-PRS-ExpectedRSTD-Uncertainty
This field indicates the uncertainty in nr-DL-PRS-ExpectedRSTD value. The uncertainty is related to the location server's a-priori
estimate of the target device location. The nr-DL-PRS-ExpectedRSTD and nr-DL-PRS-ExpectedRSTD-Uncertainty together define
the search window for the target device.
The resolution R is

| | |
|---|---|
| - | Tₛ if all PRS resources are in frequency range 2, |
| - | 4×Tₛ otherwise, |

with Tₛ=1/(15000*2048) seconds.
The target device may assume that the beginning of the subframe for the PRS of this TRP is received within the search window of
size

| | |
|---|---|
| - | [-nr-DL-PRS-ExpectedRSTD-Uncertainty×R ; nr-DL-PRS-ExpectedRSTD-Uncertainty×R] centred at T_{REF}+1 |

millisecond×N+nr-DL-PRS-ExpectedRSTD×4×Tₛ,
where T_{REF} is the reception time of the beginning of the subframe for the PRS of the assistance data reference TRP at the target
device antenna connector, and N can be calculated based on

| | |
|---|---|
| - | nr-DL-PRS-SFN0-Offset |
| - | dl-PRS-Periodicity-and-ResourceSetSlotOffset |
| - | dl-PRS-ResourceSlotOffset. |

nr-DL-PRS-Info
This field specifies the PRS configuration of the TRP.
dl-PRS-SubcarrierSpacing
This field specifies the subcarrier spacing of the DL-PRS Resource. 15, 30, 60 kHz for FR1; 60, 120 kHz for FR2.
dl-PRS-ResourceBandwidth
This field specifies the number of PRBs allocated for the DL-PRS Resource (allocated DL-PRS bandwidth) in multiples of 4 PRBs. All
DL-PRS Resources of the DL-PRS Resource Set have the same bandwidth. All DL-PRS Resource Sets belonging to the same
Positioning Frequency Layer have the same value of DL-PRS Bandwidth and Start PRB.
Integer value 1 corresponds to 24 PRBs, value 2 corresponds to 28 PRBs, value 3 corresponds to 32 PRBs and so on.
dl-PRS-StartPRB
This field specifies the start PRB index defined as offset with respect to reference DL-PRS Point A for the Positioning Frequency
Layer.
dl-PRS-PointA
This field specifies the absolute frequency of the reference resource block for the DL-PRS. Its lowest subcarrier is also known as
DL-PRS Point A. A single DL-PRS Point A for DL-PRS Resource allocation is provided per Positioning Frequency Layer. All DL-PRS
Resources belonging to the same DL-PRS Resource Set have the same DL-PRS Point A.
dl-PRS-CombSizeN
This field specifies the Resource Element spacing in each symbol of the DL-PRS Resource. All DL-PRS Resource Sets belonging to
the same Positioning Frequency Layer have the same value of comb size N.
nr-DL-PRS-ConfigRqst
This field specifies the PRS Configuration Request fields associated with the DL-PRS resources of the TRP.
dl-PRS-ConfigRqstAllowed
This field specifies whether or not the DL-PRS Resource associated with the DL-PRS resource identifier is allowed requests for
reconfiguration.
dl-PRS-measPriorityOrPrioritySet
This field specifies measurement priority of the DL-PRS Resource or Resource Set.
dl-PRS-ValidityTimer
This field specifies the Validity time (or timer) of the configuration request allowed IE associated with the DL-
PRS Resource.
dl-PRS-prohibitTimer
This field specifies a timer associated with subsequent PRS configuration requests to limit the frequency of
requests associated with the DL-PRS Resource.
dl-PRS-KPI-required
This field specifies the positioning KPIs associated with the request for PRS reconfiguration of the DL-PRS
Resource.
dl-PRS-servicetype
This field specifies the system type associated with the reconfiguration request of the DL-PRS Resource. For
example, a Value of 0 is associated with an emergency location request.
dl-PRS-accuracy
This field specifies the accuracy requirements associated with the reconfiguration request of the DL-PRS
Resource.
dl-PRS-latency
This field specifies the latency requirements associated with the reconfiguration request of the DL-PRS
Resource.
dl-PRS-IC-interference
This field specifies the inter-cell interference requirements associated with the reconfiguration request of the
DL-PRS Resource.

APPENDIX ITEM 11
-- ASN1START
::= SEQUENCE {

| | |
|---|---|
| nr-DL-PRS-RstdMeasurementInfoRequest-r16 ENUMERATED { true } | OPTIONAL,-- |

Need ON

| nr-RequestedMeasurements-r16 | BIT STRING { prsrsrpReq (0) } (SIZE(1..8)), | |
|---|---|---|
| nr-AssistanceAvailability-r16 | BOOLEAN, | |
| nr-DL-TDOA-ReportConfig-r16 | NR-DL-TDOA-ReportConfig-r16 | OPTIONAL, -- |

Need ON

| | | |
|---|---|---|
| additionalPaths-r16 | ENUMERATED { requested } | OPTIONAL, -- Need ON |

...,

| | |
|---|---|
| nr-reconfigAvailability-r17 | BOOLEAN |

}
NR-DL-TDOA-ReportConfig-r16 ::= SEQUENCE {

| | |
|---|---|
| maxDL-PRS-RSTD-MeasurementsPerTRPPair-r16 INTEGER (1..4) | OPTIONAL, -- |

Need ON

| | |
|---|---|
| timingReportingGranularityFactor-r16 INTEGER (0..5) | OPTIONAL, -- Need ON |

...
}
-- ASN1STOP

APPENDIX ITEM 12
NR-DL-TDOA-RequestLocationInformation field descriptions

nr-AssistanceAvailability
This field indicates whether the target device may request additional PRS assistance data from the server. TRUE means allowed
and FALSE means not allowed.
nr-RequestedMeasurements
This field specifies the NR DL-TDOA measurements requested. This is represented by a bit string, with a one-value at the bit
position means the particular measurement is requested; a zero-value means not requested.
nr-DL-PRS-RstdMeasurementInfoRequest
This field indicates whether the target device is requested to report DL-PRS Resource ID(s) or DL-PRS Resource Set ID(s) used for
determining the timing of each TRP in RSTD measurements.
maxDL-PRS-RSTD-MeasurementsPerTRPPair
This field specifies the maximum number of. DL-PRS RSTD measurements per pair of TRPs. The maximum number is defined
across all Positioning Frequency Layers.
timingReportingGranularityFactor
This field specifies the recommended reporting granularity for the DL RSTD measurements. Value (0..5) corresponds to (k0..k5)
used for nr-RSTD and nr-RSTD-ResultDiff in NR-DL-TDOA-MeasElement. The UE may select a different granularity value for nr-
RSTD and nr-RSTD-ResultDiff.
nr-reconfigAvailability
This field indicates whether the target device may request reconfiguration of PRS transmissions for the associated TRP.

APPENDIX ITEM 13
-- ASN1START
NR-DL-TDOA-RequestAssistanceData-r16 ::= SEQUENCE {

| | | |
|---|---|---|
| nr-PhysCellID-r16 | NR-PhysCellID-r16 | OPTIONAL, |

| | |
|---|---|
| nr-AdType-r16 | BIT STRING { dl-prs (0), |
| | posCalc (1) } (SIZE (1..8)), |

...,

| | | |
|---|---|---|
| nr-PRS-config-request | BOOLEAN | OPTIONAL, |
| dl-PRS-KPI-required | DL-PRS-KPI-required | OPTIONAL |

}
-- ASN1STOP

APPENDIX ITEM 14
NR-DL-TDOA-RequestAssistanceData field descriptions

nr-PhysCellID
This field specifies the NR physical cell identity of the current primary cell of the target device.
nr-AdType
This field indicates the requested assistance data. dl-prs means requested assistance data is nr-DL-PRS-AssistanceData, posCalc
means requested assistance data is nr-PositionCalculationAssistanceData for UE based positioning.
nr-PRS-config-request
This field indicates whether or not a target device is requesting a modification in the current PRS transmissions associated
with the NR physical cell identity of the current primary cell.
dl-PRS-KPI-required
This field specifies the positioning KPIs associated with the request for PRS configuration of the DL-PRS Resource associated
with the NR physical cell identity of the current primary cell.

APPENDIX ITEM 15
-- ASN1START
NR-DL-TDOA-ProvideLocationInformation-r16 ::= SEQUENCE {
nr-DL-TDOA-SignalMeasurementInformation-r16

| | NR-DL-TDOA-SignalMeasurementInformation-r16 | |
|---|---|---|
| | | OPTIONAL, |
| nr-dl-tdoa-LocationInformation-r16 | NR-DL-TDOA-LocationInformation-r16 | |
| | | OPTIONAL, -- Cond UEB |
| nr-DL-TDOA-Error-r16 | NR-DL-TDOA-Error-r16 | OPTIONAL, |

...,

| | | |
|---|---|---|
| nr-PRS-config-request | BOOLEAN | OPTIONAL, |
| nr-dl-PRS-KPI-required | NR-DL-PRS-KPI-required | OPTIONAL |
| nr-dl-TDOA-error-sources | NR-DL-TDOA-error-sources | OPTIONAL |

}
NR-dl-TDOA-error-sources ::= SEQUENCE {

| | | |
|---|---|---|
| nr-PRS-multipath | INTEGER (0..7) | OPTIONAL, -- for detection |

per TRP or measure/amount of multipath averaged across all measurements

| | | |
|---|---|---|
| nr-dl-PRS-NLOS-per-TRP | NR-DL-PRS-NLOS-per-TRP | OPTIONAL, |

-- for detection per TRP or beam

| | | |
|---|---|---|
| nr-dl-TDOA-TRP-trust-per-TRP | INTEGER (0..7) | OPTIONAL |

...
}
-- ASN1STOP

APPENDIX ITEM 16
NR-DL-TDOA-ProvideLocationInformation field descriptions

nr-PRS-config-request
This field indicates whether or not a target device is requesting a modification in the current PRS transmissions associated
with the current PRS measurements. Alternatively, if this IE is associated with the sub-IEs in nr-DL-TDOA-
SignalMeasurementInformation, the request may be specific to a particular PRS Resource ID, PRS Resource Set, etc.
nr-dl-PRS-KPI-required
This field specifies the positioning KPIs associated with the request for PRS configuration of the DL-PRS Resource associated
with the NR physical cell identity of the current primary cell.
nr-PRS-multipath
This field specifies the level/amount of detected positioning reference signal multipath. This may be defined
by the totality of the PRS measurements or from a single TRP/beam
nr-dl-PRS-NLOS-per-TRP
This field specifies detected line of sight for a given TRP or beam associated with the PRS signal. This may be
defined by the totality of the PRS measurements/threshold or from a particular TRP/beam
nr-dl-TDOA-TRP-trust
This field specifies whether or not a given TRP or beam associated with the PRS signal is verified to be
accurate and trustworthy.

APPENDIX ITEM 17
Short Messages

| Bit | Short Message |
|---|---|
| 1 | systeminfoModification |
| | If set to 1: indication of a BCCH modification other than SIB6, SIB7 |
| | and SIB8. NOTE: that this also includes posSIB modification |
| | indication. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum channel |
| | access and if nrofPDCCH-MonitoringOccasionPerSSB-InPO is |
| | present. |
| | If set to 1: indication that the UE may stop monitoring PDCCH |
| | occasion(s) for paging in this Paging Occasion as specified in TS |
| | 38.304 [20], clause 7.1. |
| 4 | prsMeasurementReport |
| | If set to 1: indication for a UE to instigate measurements. position or |
| | measurement report |
| 5-8 | Not used in this release of the specification, and shall be ignored by |
| | UE if received. |

APPENDIX ITEM 18
TS 38.331 sec 5.2.2.3.3a Request for on demand positioning system information

```
The UE shall:
  1> if SIB1 includes posSI-SchedulingInfo containing posSI-RequestConfigSUL and criteria to select supplementary uplink as defined in TS
    38.321[13], clause 5.1.1 is met:
    2> trigger the lower layer to initiate the Random Access procedure on supplementary uplink in accordance with [3] using the PRACH
      preamble(s) and PRACH resource(s) in posSI-RequestConfigSUL corresponding to the SI message(s) that the UE requires to operate within
      the cell, and for which posSI-BroadcastStatus is set to notBroadcasting;
    2> if acknowledgement for SI request is received from lower layers:
      3> acquire the requested SI message(s) as defined in sub-clause 5.2.2.3.2, immediately;
  1> else if SIBI includes posSI-SchedulingInfo containing posSI-RequestConfig and criteria to select normal uplink as defined in TS 38.321[13],
    clause 5.1.1 is met:
    2> trigger the lower layer to initiate the random access procedure on normal uplink in accordance with TS 38.321 [3] using the PRACH
      preamble(s) and PRACH resource(s) in posSI-RequestConfig corresponding to the SI message(s) that the UE upper layers require for
      positioning operations , and for which posSI-BroadcastStatus is set to notBroadcasting;
    2> if acknowledgement for SI request is received from lower layers:
      3> acquire the requested SI message(s) as defined in sub-clause 5.2.2.3.2, immediately,
      3>if newly acquired posSIB already exists:
        4>discard the previous values and apply new values for that posSIB
  1> else:
    2> apply the default L1 parameter values as specified in corresponding physical layer specifications except for the parameters for which
      values are provided in SIB1;
    2> apply the default MAC Cell Group configuration as specified in 9.2.2;
    2> apply the timeAlignmentTimerCommon included in SIB1;
    2> apply the CCCH configuration as specified in 9.1.1.2;
    2> initiate transmission of the RRCSystemInfoRequest message with rrcPosSystemInfoRequest in accordance with 5.2.2.3.4;
    2> if acknowledgement for RRCSystemInfoRequest message with rrcPosSystemInfoRequest is received from lower layers:
      3> acquire the requested SI message(s) as defined in sub-clause 5.2.2.3.2, immediately;
      3>if newly acquired posSIB exists:
        4>discard the previous values and apply new values for that posSIB
  1> if cell reselection occurs while waiting for the acknowledgment for SI request from lower layers:
    2> reset MAC;
    2> if SI request is based on RRCSystemInfoRequest message with rrcPosSystemInfoRequest:
      3> release RLC entity for SRB0.
NOTE:
After RACH failure for SI request it is up to UE implementation when to retry the SI request.
```

APPENDIX ITEM 19
-- ASN1START
NR-DL-TDOA-ProvideLocationInformation-r16 ::= SEQUENCE {
nr-DL-TDOA-SignalMeasurementInformation-r16

| | NR-DL-TDOA-SignalMeasurementInformation-r16 | |
|---|---|---|
| | | OPTIONAL, |
| nr-dl-tdoa-LocationInformation-r16 | NR-DL-TDOA-LocationInformation-r16 | |
| | | OPTIONAL, -- Cond UEB |
| nr-DL-TDOA-Error-r16 | NR-DL-TDOA-Error-r16 | OPTIONAL, |

...,

| | | |
|---|---|---|
| nr-PRS-config-request | BOOLEAN | OPTIONAL, |
| nr-dl-PRS-KPI-required | NR-DL-PRS-KPI-required | OPTIONAL, |
| nr-dl-TDOA-error-sources | NR-DL-TDOA-error-sources | OPTIONAL |

}
NR-dl-TDOA-error-sources ::= SEQUENCE {

| | | |
|---|---|---|
| nr-PRS-multipath | INTEGER (0..7) | OPTIONAL, -- for detection |

per TRP or measure/amount of multipath averaged across all measurements

| | | |
|---|---|---|
| nr-dl-PRS-NLOS-per-TRP | NR-DL-PRS-NLOS-per-TRP | OPTIONAL, |

-- for detection per TRP or beam

| | | |
|---|---|---|
| nr-dl-TDOA-TRP-trust-per-TRP | INTEGER (0..7) | OPTIONAL |

-- ASN1STOP

APPENDIX ITEM 20
NR-DL-TDOA-ProvideLocationInformation field descriptions

nr-PRS-config-request
This field indicates whether or not a target device is requesting a modification in the current PRS transmissions associated with
the current PRS measurements. Alternatively, if this IE is associated with the sub-IEs in nr-DL-TDOA-
SignalMeasurementInformation, the request may be specific to a particular PRS Resource ID, PRS Resource Set, etc.
nr-dl-PRS-KPI-required
This field specifies the positioning KPIs associated with the request for PRS configuration of the DL-PRS Resource associated with
the NR physical cell identity of the current primary cell.
nr-PRS-multipath
This field specifies the level/amount of detected positioning reference signal multipath. This may be defined by the
totality of the PRS measurements or from a single TRP/beam
nr-dl-PRS-NLOS-per-TRP
This field specifies detected line of sight for a given TRP or beam associated with the PRS signal. This may be defined
by the totality of the PRS measurements/threshold or from a particular TRP/beam
nr-dl-TDOA-TRP-trust
This field specifies whether or not a given TRP or beam associated with the PRS signal is verified to be accurate and
trustworthy.

APPENDIX ITEM 21
-- ASN1START
NR-DL-TDOA-TargetDeviceErrorCauses-r16 ::= SEQUENCE {

| | |
|---|---|
| cause-r16 | ENUMERATED { undefined, |
| | assistance-data-missing, |
| | unableToMeasureAnyTRP, |
| | attemptedButUnableToMeasureSomeNeighbourTRPs, |
| | thereWereNotEnoughSignalsReceivedForUeBasedDL-TDOA, |
| | locationCalculationAssistanceDataMissing, |
| | ..., multipath, nlosTRPthresholdExceeded, trpNotReliable |
| | }, |

...
}
-- ASN1STOP

APPENDIX ITEM 22

| | |
|---|---|
| 3GPP | 3rd Generation Partnership Project |
| AMF | Access and Mobility Management Function |
| AD | Assistance Data |
| AoD | Angle of Departure |
| BW | Bandwidth |
| CCCH | Common Control Channel |
| CF | Control Plane |
| DCI | Downlink Control Information |
| DL | Downlink |
| DTCH | Dedicated Traffic Channel |
| EDT | Early Data Transmissions |
| GMLC | Gateway Mobile Location Center |
| GNSS | Global Navigation Satellite System |
| GPS | Global Positioning System |
| IE | Information Element |
| IoT | Internet of Things |
| KPI | Key Performance Indicator |
| LCID | Logical Channel IDentifier |
| LCS | LoCation Services |
| LMF | Location Management Function (may be used |
| | interchangeably with Network or Location Server) |
| LOS | Line Of Sight |
| LPP | LTE Positioning Protocol |
| LTE | Long Term Evolution |
| MAC | Medium Access Control |
| MAC-CE | Medium Access Control-Control Element |
| NAS | Non-Access Stratum |
| NLOS | Non-Line Of Sight |
| NR | New Radio |
| NCGI | NR Cell Global Identifier |
| NRPPa | New Radio Positioning Protocol A |
| P2P | Point-to-Point |
| posSIB | Positioning SIB |
| PRS | Positioning Reference Signal |
| RACH | Random Access CHannel |
| RAN | Radio Access Network |
| RAT | Radio Access Technology |
| REDCAP | Reduced Capabilities |
| RNA | RAN Notification Area |
| RNTI | Radio Network Temporary Identifier |
| RRC | Radio Resource Control |
| RSRP | Reference Signal Received Power |
| RSTD | Reference Signal Time Difference |
| RTT | Round Trip Time |
| SDT | Small Data Transmission |
| SI | System Information |
| SIB | System Information Block |
| S-NSSAI | Single - Network Slice Selection Assistance Information |
| SUPL | Secure User Plane Location |
| TA | Tracking Area |
| TDOA | Time Difference of Arrival |
| TRP | Transmission Reception Point (may be used |
| | interchangeably with gNB) |
| UE | User Equipment |
| UE-A | User Equipment-Assisted |
| UE-B | User Equipment-Based |
| UL | Uplink |
| UP | User Plane |
| UPF | User Plane Functions |
| Uu Interface | Radio interface between the mobile and the radio access |
| | network |

1-20. (canceled)

21. A wireless transmit/receive unit (WTRU) comprising a processor, communication circuitry, a memory, and computer-executable instructions stored in the memory which, when executed by the processor, cause the WTRU to:
receive a first Positioning Reference Signal (PRS) configuration comprising an indication of PRS reconfiguration criteria:
receive, from a base station (gNB), a first PRS in accordance with the first PRS configuration:
perform one or more measurements of the first PRS;
if the measurements meet the PRS reconfiguration criteria, send to an apparatus performing a Location Management Function (LMF), a PRS reconfiguration request comprising an indication of a priority, an urgency indication, or a quality metric associated with the PRS request requirement;
receive, from the LMF, a second PRS configuration after sending the PRS reconfiguration request; and
receive, from the gNB, a second PRS in accordance with the second PRS configuration.

22. The WTRU of claim 21, wherein the urgency indication comprises information associated with an emergency communication process involving the WTRU.

23. The WTRU of claim 21, wherein the indication of priority indicates a priority of the PRS reconfiguration request with respect to at least one other PRS reconfiguration request to be processed by the LMF.

24. The WTRU of claim 21, wherein the computer-executable instructions, when executed, further cause the WTRU to calculate a position of the WTRU based on the second PRS.

25. The WTRU of claim 21, wherein the PRS reconfiguration request comprises an indication of a required positioning accuracy.

26. The WTRU of claim 21, wherein the PRS reconfiguration request comprises an indication of a required quality of service, of a service that uses the WTRU position.

27. The WTRU of claim 21, wherein the PRS reconfiguration request comprises an indication of a required latency of the WTRU position calculation.

28. The WTRU of claim 21, wherein the PRS reconfiguration request comprises an indication of signal measurements and/or a position estimate of the WTRU.

29. The WTRU of claim 21, wherein the PRS reconfiguration request comprises an indication of a capability of the WTRU.

30. The WTRU of claim 21, wherein the first PRS configuration and the second PRS configuration are sent using New Radio Positioning Protocol A (NRPPa).

31. The WTRU of claim 21, wherein the second PRS configuration comprises an indication of a period of time in which the second PRS configuration is to be used.

32. A method performed by a wireless transmit/receive unit (WTRU) comprising:
receiving a first Positioning Reference Signal (PRS) configuration comprising an indication of PRS reconfiguration criteria:
receiving, from a base station (gNB), a first PRS in accordance with the first PRS configuration;
performing one or more measurements of the first PRS;
if the measurements meet the PRS reconfiguration criteria, sending to an apparatus performing a Location Management Function (LMF), a PRS reconfiguration request comprising an indication of a priority, an urgency indication, or a quality metric associated with the PRS request requirement;
receiving, from the LMF, a second PRS configuration after sending the PRS reconfiguration request; and
receiving, from the gNB, a second PRS in accordance with the second PRS configuration.

33. The WTRU of claim 32, wherein the urgency indication comprises information associated with an emergency communication process involving the WTRU.

34. The method of claim 32, wherein the indication of priority indicates a priority of the PRS reconfiguration request with respect to at least one other PRS reconfiguration request to be processed by the LMF.

35. The method of claim 32, further comprising:
calculating a position of the WTRU based on the second PRS.

36. The method of claim 32, wherein the PRS reconfiguration request comprises an indication of a required positioning accuracy.

37. The method of claim 32, wherein the PRS reconfiguration request comprises an indication of a required quality of service, of a service that uses the WTRU position.

38. The method of claim 32, wherein the PRS reconfiguration request comprises an indication of a required latency of the WTRU position calculation.

39. The method of claim 32, wherein the PRS reconfiguration request comprises an indication of signal measurements and/or a position estimate of the WTRU.

40. The method of claim 32, wherein the PRS reconfiguration request comprises an indication of a capability of the WTRU.
